(19) United States
(12) Patent Application Publication
(10) Pub. No.: US 2013/0197951 A1
(43) Pub. Date: Aug. 1, 2013

(54) Incident Management and Monitoring Systems and Methods

(71) Applicants: Christopher Evan Watson, Monroeville, PA (US); Chadd M. Cron, Gibsonia, PA (US); Scott R. Pavetti, Springdale, PA (US)

(72) Inventors: Christopher Evan Watson, Monroeville, PA (US); Chadd M. Cron, Gibsonia, PA (US); Scott R. Pavetti, Springdale, PA (US)

(21) Appl. No.: 13/558,987

(22) Filed: Jul. 26, 2012

Related U.S. Application Data
(60) Provisional application No. 61/572,993, filed on Jul. 26, 2011.

(51) Int. Cl. G06Q 10/06

(52) U.S. Cl. CPC G06Q 10/06
USPC 705/7.12

(57) ABSTRACT

An incident management and monitoring system, including: at least one central controller configured to receive global resource data, user data, and organizational data; and at least one user interface in direct or indirect communication with the at least one central controller and configured to display content comprising at least one of the following: at least a portion of the global resource data; at least a portion of the user data, at least a portion of the organizational data, at least one selectable element, at least one configurable element, at least one control element, at least one user input area, visual data, processed data, or any combination thereof. A user interface for incident management and monitoring is also provided.

### CROSS REFERENCE TO RELATED APPLICATIONS

This application claims benefit of priority from U.S. Provisional Patent Application No. 61/572,993, filed Jul. 26, 2011, which is incorporated herein by reference in its entirety.

### BACKGROUND OF THE INVENTION

1. Field of the Invention

The present invention relates generally to command structures and incident and accountability management techniques and systems that are used to manage and control numerous resources and assets at or involved with an event, and in particular to an incident management and monitoring system and method for use in a variety of applications and situations, such as at the scene of an incident or emergency.

2. Description of the Related Art

In many emergency situations and environments, first responders and other personnel must work quickly to establish a command structure and/or organization to appropriately manage and monitor the incident. In particular, this command structure or system is required in order to effectively resolve the situation while minimizing risk to the responders and/or other people at the scene. As is known, and with respect to incident scene accountability, all officers holding positions within the command organization are responsible for the welfare and accurate accountability of all assigned personnel. In many of these known command organizations roles for people or groups of people are assigned and/or identified in order to effectively distribute information and manage the scene. For example, these incident command roles may include: Incident Commander, Operations Command, Incident Safety Officer, Accountability Officer, Air Management Officer, Rehab/Firefighter Medical Command Officer, and Staging Area Manager.

Several fire ground accountability systems have been developed by various fire departments around the country. While they may vary in overall design, there are common elements of personnel accountability that fire departments normally apply at emergency incidents to account for their personnel fully. Some of these common elements include: required use (of the system); identity of personnel (tags (e.g., RFID tags) and/or documentation, whether in electronic or paper form); point-of-entry control; identification of an accountability officer; benchmarks for required roll-calls throughout operations; plans for describing the command organization response to reports of lost personnel; and use of Rapid Intervention Crews (RICs). Some of these common elements and actions are described in NIMS—Incident Command System for the Fire Service—Student Manual—1st Edition, 1st Printing, January 2005.

The above-referenced National Incident Management System (NIMS) Incident Command System (ICS) was developed in the 1970s following a series of catastrophic fires in California's urban interface. Property damage ran into the millions, and many people died or were injured. The personnel assigned to determine the causes of these outcomes studied the case histories and discovered that response problems could rarely be attributed to lack of resources or failure of tactics. Instead, studies found that response problems were far more likely to result from inadequate management than from any other single reason. Accordingly, the ICS was developed, which represents: a standardized management tool for meeting the demands of small or large emergency or non-emergency situations; “best practices” and the standard for emergency management across the country; a resource for planned events, natural disasters, and acts of terrorism; a key feature of the NIMS ICS.

The NIMS ICS organizational structure includes:

Command Staff, which consists of the Public Information Officer, Safety Officer, and Liaison Officer reporting directly to the Incident Commander;

General Staff, which is directed to the organization level having functional responsibility for primary segments of incident management (e.g., Operations, Planning, Logistics, Finance/Administration), and which is organizationally between Branch and Incident Commander;

Section, which is directed to the organizational level having functional responsibility for primary segments of the incident;

Branch, which is directed to the organizational level having functional, geographical, or jurisdictional responsibility for major parts of the incident operations and is organizationally between Section and Division/Group in the Operations Section, and between Section and Units in the Logistics Section;

Sector, which is a functional element of the ICS that is equal to a Division or Group, and may be either a geographic Sector (e.g., Sector A) or a functional Sector (e.g. Vent Sector);

Division, which is directed to the organizational level having responsibility for operations within a defined geographic area, and is organizationally between the Strike Team and the Branch;

Group, which are established to divide the incident into functional areas of operation, and are located between Branches (when activated) and Resources in the Operations Section;

Unit, which is an organizational element having functional responsibility for a specific incident planning, logistics, or finance/administration activity;

Task Force, which is directed to a group of resources with common communications and a leader that may be pre-established and sent to an incident, or formed at an incident, including any type or kind of resources, with common communications and a leader, temporarily assembled for specific tactical missions;

Strike Team, which include specified combinations of the same kind and type of resources, with common communications and a leader; and

Single Resource, which refers to an individual piece of equipment and its personnel complement, or an established crew or team of individuals with an identified work supervisor that can be used on an incident, e.g., individual engines, squads, ladder trucks, rescues, crews, and the like.

Further, and as is known, there exist 14 components of NIMs outlining the requirements to provide unified command, including the following:

Common Terminology: ICS establishes common terminology that allows diverse incident management and support organizations to work together across a wide variety of incident management functions and hazard scenarios. This common terminology covers the following: Organizational Functions (Major functions and functional units with incident management responsibilities are named and defined. Terminology for the organizational elements is standard and consistent.); Resources Descriptions (Major resources—including personnel, facilities, and major equipment and supply items, which support incident management activities are given common names and are “typed” with respect to their capabilities, to help avoid confusion and to enhance interoperability.); and Incident Facilities (Common terminology is used to designate the facilities in the vicinity of the incident area that will be used during the course of the incident.)

Modular Organization: The ICS organizational structure develops in a modular fashion based on the size and complexity of the incident, as well as the specifics of the hazard environment created by the incident. When needed, separate functional elements can be established, each of which may be further subdivided to enhance internal organizational management and external coordination. Responsibility for the establishment and expansion of the ICS modular organization ultimately rests with Incident Command, which bases the ICS organization on the requirements of the situation. As incident complexity increases, the organization expands from the top down as functional responsibilities are delegated. Concurrently with structural expansion, the number of management and supervisory positions expands to address the requirements of the incident adequately.

Management by Objectives: Management by objectives is communicated throughout the entire ICS organization and includes: establishing overarching incident objectives; developing strategies based on overarching incident objectives; developing and issuing assignments, plans, procedures, and protocols; establishing specific, measurable tactics or tasks for various incident management functional activities, and directing efforts to accomplish them, in support of defined strategies; and documenting results to measure performance and facilitate corrective actions.

Incident Action Plan: Centralized coordinated incident action planning should guide all response activities. An Incident Action Plan (IAP) provides a concise, coherent means of capturing and communicating the overall incident priorities, objectives, and strategies in the contexts of both operational and support activities. Every incident must have an action plan. However, not all incidents require written plans. The need for written plans and attachments is based on the requirements of the incident and the decision of the Incident Commander or Unified Command. Most initial response operations are not captured with a formal IAP. However, if an incident is likely to extend beyond one operational period, become more complex, or involve multiple jurisdictions and/or agencies, preparing a written IAP will become increasingly important to maintain effective, efficient, and safe operations.

Manageable Span of Control: Span of control is one key to effective and efficient incident management. Supervisors must be able to adequately supervise and control their subordinates, as well as communicate with and manage all resources under their supervision. In ICS, the span of control of any individual with incident management supervisory responsibility should range from 3 to 7 subordinates, with 5 being optimal. During a large-scale law enforcement operation, 8 to 10 subordinates may be optimal. The type of incident, nature of the task, hazards and safety factors, and distances between personnel and resources all influence span-of-control considerations.

Incident Facilities and Locations: Various types of operational support facilities are established in the vicinity of an incident, depending on its size and complexity, to accomplish a variety of purposes. The Incident Command will direct the identification and location of facilities based on the requirements of the situation. Typical designated facilities include Incident Command Posts, Bases, Camps, Staging Areas, mass casualty triage areas, point-of-distribution sites, and others, as required.

Comprehensive Resource Management: Maintaining an accurate and up-to-date picture of resource utilization is a critical component of incident management and emergency response. Resources to be identified in this way include personnel, teams, equipment, supplies, and facilities available or potentially available for assignment or allocation.

Integrated Communications: Incident communications are facilitated through the development and use of a common communications plan and interoperable communications processes and architectures. The ICS 205 form is available to assist in developing a common communications plan. This integrated approach links the operational and support units of the various agencies involved, and is necessary to maintain communications connectivity and discipline and to enable common situational awareness and interaction. Preparedness planning should address the equipment, systems, and protocols necessary to achieve integrated voice and data communications.

Establishment and Transfer of Command: The command function must be clearly established from the beginning of incident operations. The agency with primary jurisdictional authority over the incident designates the individual at the scene responsible for establishing command. When command is transferred, the process must include a briefing that captures all essential information for continuing safe and effective operations.

Chain of Command and Unit of Command: Chain of Command (Chain of command refers to the orderly line of authority within the ranks of the incident management organization.); and Unity of Command (Unity of command means that all individuals have a designated supervisor to whom they report at the scene of the incident. These principles clarify reporting relationships and eliminate the confusion caused by multiple, conflicting directives. Incident managers at all levels must be able to direct the actions of all personnel under their supervision.)

Unified Command: In incidents involving multiple jurisdictions, a single jurisdiction with multi-agency involvement, or multiple jurisdictions with multi-agency involvement, Unified Command allows agencies with different legal, geographic, and functional authorities and responsibilities to work together effectively without affecting individual agency authority, responsibility, or accountability.

Accountability of Resources and Personnel: Effective accountability of resources at all jurisdictional levels and within individual functional areas during incident operations is essential. Adherence to the following ICS principles and processes helps to ensure accountability: resource check-in/check-out procedures; incident action planning; unity of command; personal responsibility; span of control; and resource tracking.

Dispatched/Deployment: Resources should respond only when requested or when dispatched by an appropriate authority through established resource management systems. Resources not requested must refrain from spontaneous deployment to avoid overburdening the recipient and compounding accountability challenges.

Information and Intelligence Management: The incident management organization must establish a process for gathering, analyzing, assessing, sharing, and managing incident-related information and intelligence.

Known incident work flow steps used, for example, in fire-based emergency situations includes: (1) initial force is deployed for tactical action; (2) as deployed operational force abilities are exhausted, operational force replenished form staged force; and (3) replenished operational force are rehabilitated and returned to staging for future deployment. Similarly, Mine Safety Appliances Co. has an existing accountability system that is used by first responders at various emergency situations. One exemplary screenshot from this existing MSA system is illustrated in FIG. 1, and this existing MSA system provides Incident Commanders with an Air Management data display. Data is provided by a low-bandwidth data radio integrated into the supported-model Self Contained Breathing Apparatus (SCBA). As shown in FIG. 1, the user interface has a command bar across the top, available teams in the main panel, and a detailed view of the selected team in the left panel. Further certain user data and user-related data are provided at this interface, such as user name, team, team position, breathing air, pressure, time remaining, end-of-service time indicator (EOSTI) alarm, personal alert safety system (PASS), manual alarm, automatic alarm, high temperature alarm, low battery alarm, and two-way evacuation (EVAC) signal. Additionally, as seen in FIG. 1, the top bar allows the user to print reports, add and remove teams, evacuate all personnel at the incident and monitor incident time and Personal Accountability Report (PAR) timer.

With continued reference to FIG. 1, the team panel displays available teams with limited user data, and the detailed panel at the left shows the details of the selected team. The teams panel limited data includes the team name, user names, user status (green good, red bad), team evacuation status, and ability to evacuate the team and radio link status. Further, the detail panel displays the details of the selected team. The details include the user name, breathing air pressure, breathing air time remaining, temperature alarm, radio link status, low battery alarm, evacuation status, and PASS alarm status. However, this existing system provides minimal connections to the Incident Command system and requires manual correlation to the Incident Command structure, as well as manual tracking of the personnel's activities and location. Manual tracking is accomplished using paper, plastic name tags, photo identification tags, or a combination of such devices.

Accordingly, there remains a need in the art for systems and methods that improve upon and/or provide incident command and control functionality at an emergency scene. As the primary and most important resource in all emergency situations is personnel, keeping these first responders safe is of the utmost importance. This can be accomplished, or vastly improved, by collecting, processing, and acting upon data that is available or created at the scene. Therefore, collection, monitoring, management, processing, control, and user of this data are important components for providing an integrated and useful incident management and monitoring systems and methods.

### SUMMARY OF THE INVENTION

Generally, the present invention provides incident management and monitoring systems and methods that address or overcome certain drawbacks and deficiencies existing in known incident command support systems. Preferably, the present invention provides incident management and monitoring systems and methods that are useful in connection with navigation systems and other systems that are deployed during an incident and in an emergency situation. Preferably, the present invention provides incident management and monitoring systems and methods that provide access to, processing of, and control over various data streams in order to assist users and command personnel in making dynamic decisions in an emergency environment. Preferably, the present invention provides incident management and monitoring systems and methods that can generate various user interfaces that allow the user to effectively manage the emergency situation.

In one preferred and non-limiting embodiment, provided is an incident management and monitoring system, including: at least one central controller configured to receive global resource data, user data, and organizational data; wherein the global resource data comprises at least one of the following: structure data, environment data, scene data, geographic data, computer aided dispatch data, municipal data, government data, standards data, vehicle data, tag data, weather data, aid data, or any combination thereof; wherein the user data comprises at least one of the following: personnel data, equipment data, wireless-enabled device data, alarm device data, self contained breathing apparatus data, navigation data, status data, alarm data, or any combination thereof; and wherein the organizational data comprises at least one of the following: operations data, section data, branch data, division data, group data, resource data, or any combination thereof; and at least one user interface in direct or indirect communication with the at least one central controller and configured to display content comprising at least one of the following: at least a portion of the global resource data; at least a portion of the user data, at least a portion of the organizational data, at least one selectable element, at least one configurable element, at least one control element, at least one user input area, visual data, processed data, or any combination thereof.

In another preferred and non-limiting embodiment, provided is a user interface for incident management and monitoring, including: on at least one computer having a computer readable medium with program instructions thereon, which, when executed by a processor of the computer, cause the processor to: receive data from at least one central controller, the data comprising at least one of the following: global resource data, user data, organizational data, or any combination thereof; transmit data based at least in part upon user interaction with the user interface; generate content for display to the at least one user, the content comprising: (i) at least one primary data area displayed in at least one primary data section; and (ii) at least one secondary data area displayed in at least one secondary data section; wherein the at least one secondary data area is associated with at least one primary data area; and based upon user input, at least partially modify the association between the at least one secondary data area and the at least one primary data area.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is an exemplary screenshot of a user interface for an existing incident management system according to the prior art;

FIG. 2 is a schematic view of one embodiment of an incident management and monitoring system according to the principles of the present invention;

FIG. 3 is a schematic view of another embodiment of an incident management and monitoring system according to the principles of the present invention;

FIG. 4 is an organizational chart for use in connection with an incident management and monitoring system according to the principles of the present invention;

FIG. 5 is graphical view of an assignment process in an incident management and monitoring system according to the principles of the present invention;

FIG. 6 is a flow diagram of one embodiment of a work flow process in an incident management and monitoring system according to the principles of the present invention;

FIG. 7 is a schematic view of one embodiment of a user interface for an incident management and monitoring system according to the principles of the present invention;

FIG. 8 is a screenshot of a functional portion of one embodiment of a user interface for an incident management and monitoring system according to the principles of the present invention;

FIG. 9 is a screenshot of a functional portion of the user interface of FIG. 8;

FIG. 10 is a screenshot of a functional portion of the user interface of FIG. 8;

FIG. 11 is a screenshot of a functional portion of the user interface of FIG. 8;

FIG. 12 is a screenshot of a functional portion of the user interface of FIG. 8;

FIG. 13 is a screenshot of a functional portion of the user interface of FIG. 8;

FIG. 14 is a screenshot of a functional portion of the user interface of FIG. 8;

FIG. 15 is a screenshot of a functional portion of the user interface of FIG. 8;

FIG. 16 is a screenshot of a functional portion of the user interface of FIG. 8;

FIG. 17 is a screenshot of a functional portion of the user interface of FIG. 8;

FIG. 18 is a screenshot of a functional portion of the user interface of FIG. 8;

FIG. 19 is a screenshot of a functional portion of the user interface of FIG. 8;

FIG. 20 is a screenshot of a functional portion of the user interface of FIG. 8;

FIG. 21(a) is a screenshot of a functional portion of the user interface of FIG. 8;

FIG. 21(b) is a screenshot of a functional portion of the user interface of FIG. 8;

FIG. 21 is a screenshot of a functional portion of the user interface of FIG. 8;

FIG. 22 is a screenshot of a functional portion of the user interface of FIG. 8;

FIG. 23 is a screenshot of a functional portion of the user interface of FIG. 8;

FIG. 24 is a screenshot of a functional portion of the user interface of FIG. 8;

FIG. 25 is a screenshot of a functional portion of the user interface of FIG. 8;

FIG. 26 is a screenshot of a functional portion of the user interface of FIG. 8;

FIG. 27 is a screenshot of a functional portion of the user interface of FIG. 8;

FIG. 28 is a screenshot of a functional portion of the user interface of FIG. 8;

FIG. 29 is a screenshot of a functional portion of the user interface of FIG. 8;

FIG. 30 is a screenshot of a functional portion of the user interface of FIG. 8;

FIG. 31 is a screenshot of a functional portion of the user interface of FIG. 8;

FIG. 32 is a screenshot of a functional portion of the user interface of FIG. 8;

FIG. 33 is a screenshot of a functional portion of the user interface of FIG. 8;

FIG. 34 is a screenshot of a functional portion of the user interface of FIG. 8;

FIG. 35 is a screenshot of a functional portion of the user interface of FIG. 8;

FIG. 36 is a screenshot of a functional portion of the user interface of FIG. 8;

FIG. 37 are graphical views of data portions of another embodiment of a user interface for an incident management and monitoring system according to the principles of the present invention;

FIG. 38 is a graphical view of data portions of another embodiment of a user interface for an incident management and monitoring system according to the principles of the present invention;

FIGS. 39(a)-(j) are graphical views of data portions of a further embodiment of a user interface for an incident management and monitoring system according to the principles of the present invention;

FIGS. 40(a)-(e) are graphical views of data portions of a still further embodiment of a user interface for an incident management and monitoring system according to the principles of the present invention; and

FIG. 41 is a screenshot of a functional portion of the user interface of FIG. 8.

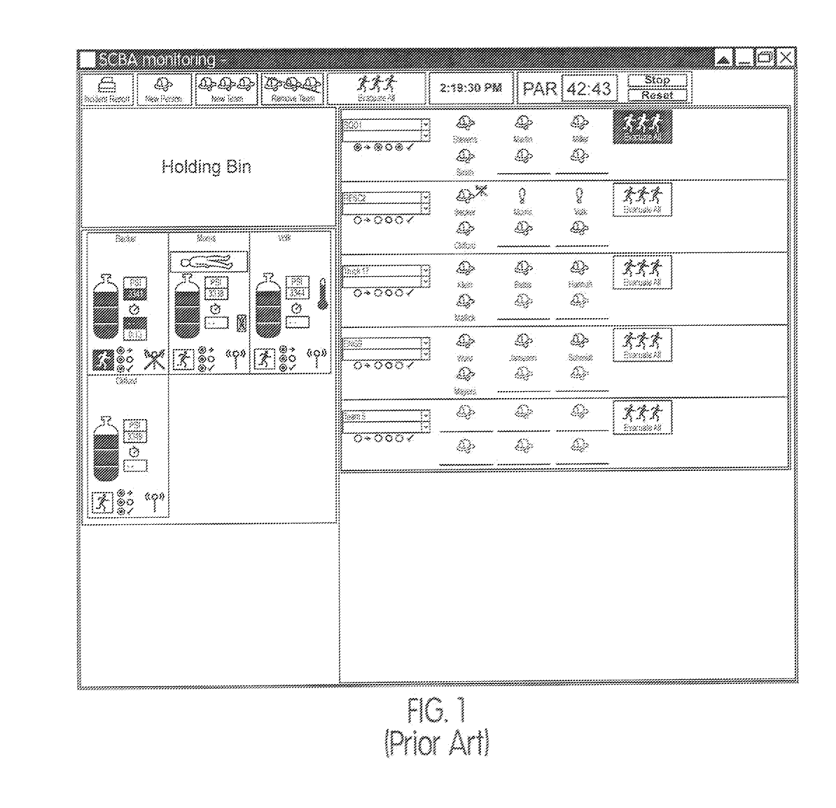

### DETAILED DESCRIPTION OF THE PREFERRED EMBODIMENTS

It is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

The present invention relates to an incident management and monitoring system 10, a user interface 100 for incident management and monitoring, and associated methods, with particular use in the fields of incident management, emergency management, scene management, warfare, tactical deployment situations, and the like. The presently-invented system 10, user interface 100, and methods have particular use in connection with incident management involving fires and other disasters and/or emergencies. However, the present invention is not limited to any particular type of incident management and monitoring, and can be effectively implemented in a variety of scenarios and events, regardless of length or complexity.

In addition, it is to be understood that the system 10, user interface 100, and associate methods can be implemented in a variety of computer-facilitated or computer-enhanced architectures and systems. Accordingly, as used hereinafter, a “computer,” a “controller,” a “central controller,” and the like refer to any appropriate computing device that enables data receipt, processing, and/or transmittal. In addition, it is envisioned that any of the computing devices or controllers discussed hereinafter include the appropriate firmware and/or software to implement the present invention, thus making these devices specially-programmed units and apparatus. Further, as used hereinafter, a “communication device” and the like refer to any appropriate device or mechanism for transfer, transmittal, and/or receipt of data, regardless of format. Still further, the communication may occur in a wireless (e.g., short-range radio, long-range radio, Bluetooth®, and the like) or hard-wired format, and provide for direct or indirect communication.

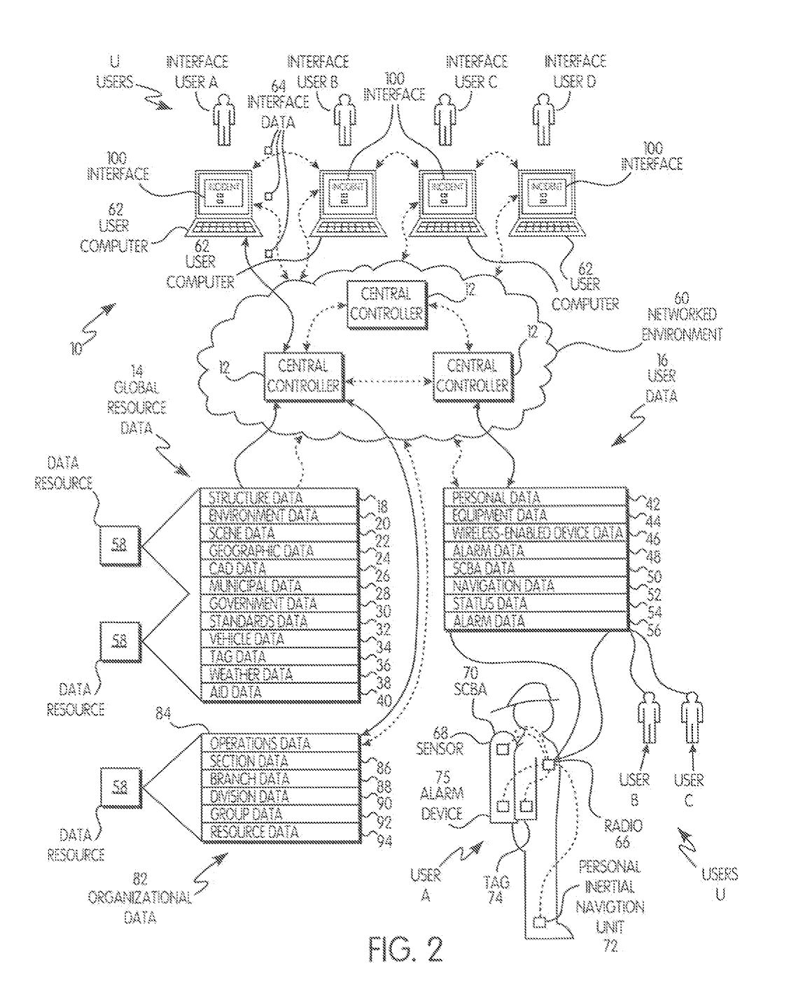

As illustrated in schematic form in FIG. 2, and in one preferred and non-limiting embodiment, the incident management and monitoring system 10 of the present invention includes at least one central controller 12 configured to receive global resource data 14, user data 16, and/or organizational data 82. The global resource data 14 includes, but is not limited to, structure data 18, environment data 20, scene data 22, geographic data 24, computer aided dispatch data 26, municipal data 28, government data 30, standards data 32, vehicle data 34, tag data 36, weather data 38, and/or aid data 40. Further, the user data 16 includes, but is not limited to, personnel data 42, equipment data 44, wireless-enabled device data 46, alarm device data 48, self contained breathing apparatus (SCBA) data 50, navigation data 52, status data 54, and/or alarm data 56. Still further, the organizational data 82 includes, but is not limited to, operations data 84, section data 86, branch data 88, division data 90, group data 92, and/or resource data 94. These data streams and examples of content will be provided hereinafter.

In addition, and as shown in FIG. 2, this data is generated by, derived from, or otherwise created by various data resources 58, including, but not limited to third-party databases, static data sources, dynamic data sources, remote databases, local databases, input data, output data, remote components and/or devices, local components and/or devices, wireless data resources, programmed data resources and databases, and the like. Accordingly, the central controller 12 is programmed, configured, or adapted to receive, process, and/or transmit the global resource data 14, user data 16, and/or organizational data 82 from or to a variety of local or remote data resources 58, typically in wireless format over a networked environment 60, such as a local area network, a wide area network, the Internet, a secured network, an unsecured network, a virtual private network, or the like.

With continued reference to FIG. 2, and in this preferred and non-limiting embodiment, the system 10 further includes at least one user interface 100, which is in direct or indirect communication with the central controller 12. This user interface 100 (which normally comprises multiple layers (or pages, screens, areas, and the like)) is programmed, configured, or adapted to display content to one or more users U. This content includes, but is not limited to, at least a portion of the global resource data 14, at least a portion of the user data 16, at least a portion of the organizational data 82, at least one selectable element, at least one configurable element, at least one control element, at least one user input area, visual data, and/or processed data.

In particular, it is this user interface 100 (as discussed in detail hereinafter) that provides a variety of users U operating in different roles with the ability to receive and understand the data that is being provided to, processed by, and/or generated by or within the system 10. By having access to this data, such as some or all of the global resource data 14, the user data 16, the organizational data 82, the various user U can make decisions and otherwise manage the incident, including all of the resources (personnel, vehicles, equipment, and the like) designated for and/or utilized in the incident. As shown in the embodiment of FIG. 2, a plurality of users (i.e., interface user A, interface user B, interface user C, and interface user D) have access to a respective user computer 62, which is programmed, configured, or adapted to receive, process, and/or utilize at least a portion of the global resource data 14, the user data 16, and/or the organizational data 82 to generate the content for display at the user interface 100. These user computers 62 can be in the form of a desktop computer, a laptop computer, a notebook computer, a personal digital assistant, a remote computing device, a local computing device, and the like. It is further envisioned that each user interface 100 and/or each user computer 62 may act as a data resource 58 by: (1) receiving data directly or indirectly from another data resource 58 and providing some or all of that data to the system 10 as interface data 64; and/or (2) creating or generating interface data 64 on the user computer 62 and/or at the user interface 100 and providing some or all of that interface data 64 to the system 10.

In another preferred and non-limiting embodiment, as illustrated in FIG. 2, the system 10 includes multiple central controllers 12 that are in wireless communication with each other over the networked environment 60. Each central controller 12 is programmed, configured, or adapted to operate and function as discussed above. Further these central controllers 12 are programmed, configured, or adapted to receive and transmit data between and among them. Using multiple central controllers 12 has various benefits, including, but not limited to: (1) dynamic data aggregation and storage for data redundancy in the case of failure or other issues when using a single central controller 12; (2) efficient and optimized data communication that facilitates secure and effective data flow within the system 10; and (3) user convenience when users U need to interact directly and locally with the central controller 12. The networked environment 60 over which these central controllers 12 communicate may be in the form a mesh, a ring, a star, a tree, or any other network topology.

With continued reference to the preferred and non-limiting embodiment of FIG. 2, at least a portion of the user data 16 is received from at least one wireless-enabled device that is associated with a specified user U. The at least one wireless-enabled device may be in the form of and/or configured to receive data from: a radio 66, user equipment, a sensor 68, a self contained breathing apparatus (SCBA) 70, a personal navigation unit, a personal inertial navigation unit 72, a signal emitting device, a tag, a radio frequency identification tag 74, and/or an alarm device 75. In this embodiment, the radio 66, which is worn by each user U (e.g., user A, user B, and user C) is programmed, configured, or adapted to operate as the on-body telemetry hub and identifier. This hub permits other devices, e.g., the sensor 68, the SCBA 70, the personal inertial navigation unit 72, the radio frequency identification tag 74, and/or the alarm device 75 to wired or wirelessly (e.g., short-range signals) connect to the radio 66, which, in turn, wirelessly (e.g., long-range signals) communicates directly or indirectly to the central controller 12. The radio 66 is equipped to receive, process, and/or generate user data 16 which can be captured remotely or locally and used within the system 10.

While not limiting, in this embodiment, user A, user B, and user C are firefighters or other personnel that are deployed at and operating within the incident. Accordingly, each user A, B, and C is wearing equipment, normally including the radio 66, sensors 68, SCBA 70, personal inertial navigation unit 72, radio frequency identification tag 74, and alarm device 75 (e.g., a PASS alarm), amongst other incident-dependent equipment and gear. It is envisioned that some or all of the user data 16 can be derived by and/or directly or indirectly received from the central controller 12 and/or the radio 66.

As discussed above, the various interface users U (e.g., interface user A, interface user B, interface user C, and interface user D) interact with the user interface 100 and provide interface data 64 to the system 10, whether data received at the user interface 100 and/or the user computer 62, or data generated by or at the user interface 100 and/or the user computer 62. This interface data 64 is received directly or indirectly by the central controller 12. Further, the central controller 12 is further programmed, configured, or adapted to transmit data to at least one wireless-enabled device associated with a specified user U (e.g., user A, user B, and user C) based at least partially on some or all of the interface data 64.

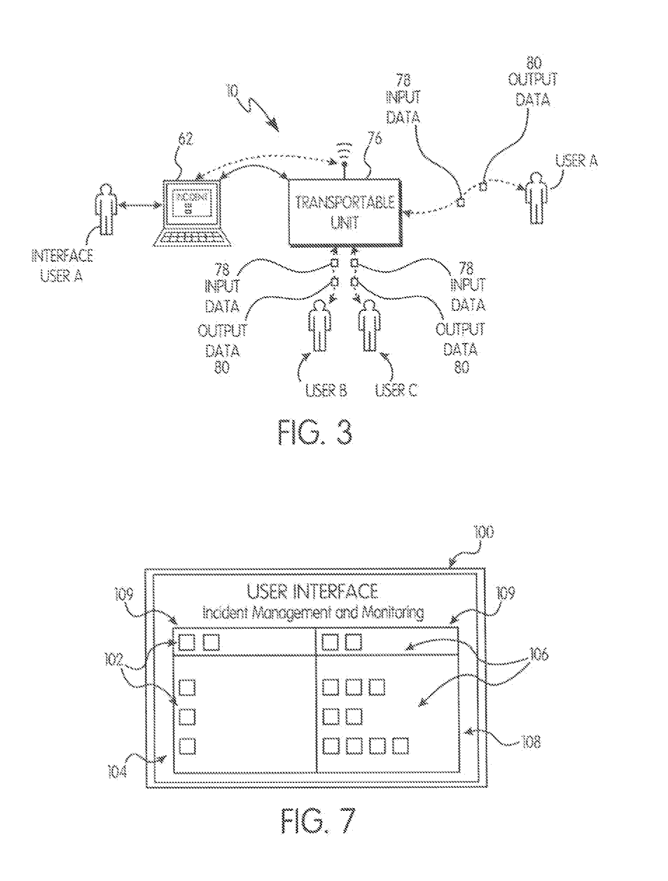

In a further preferred and non-limiting embodiment, and as illustrated in schematic form in FIG. 3, the central controller 12 is in the form a transportable unit 76 sized, shaped, and configured to be positioned at the scene of an incident. For example, one or more of these units 76 can be positioned at the scene, and permit direct and/or indirect interaction with multiple users U (e.g., user A, user B, and user C). In this embodiment, user B and user C interact with (i.e., provide input data 78 to and receive output data 80 from) the transportable unit 76 by standing near it, and using short-range wireless communication. For example, the user U may use the transportable unit 76, the radio 66, the personal inertial navigation unit 72, and/or the radio frequency identification tag 74 to initialize into the system and environment. Similarly, and as the users U move around the scene, the user U may provide input data 78 to and receive output data 80 from the transportable unit 76 using long-range wireless communication. This normally occurs through the use of the radio 66. It is envisioned that the input data 78 is in the form of user data 16, while the output data 80 is in the form of interface data 64 or other global-type data.

Further, the central controller 12, such as in the form of the transportable unit 76, can be used to initialize the user U into the system 10, facilitate the deployment of the user U at the scene, and/or facilitate effective communication and data transfer through all levels of the system 10. In addition, the central controller 12 can be located or positioned in a common frame of reference relating to the scene, and through interaction with each of the navigating users U, the central controller 12 can use certain user data 16 to locate each user in this common frame of reference. Such location and positioning techniques could include inertial navigation systems and components (e.g., each user's personal inertial navigation unit 72) or other positioning systems and components (e.g., the Global Positioning System (GPS) or other geographic information systems).

As discussed above, the user data 16 includes various data streams, such as personnel data 42, equipment data 44, wireless-enabled device data 46, alarm device data 48, SCBA data 50, navigation data 52, status data 54, and alarm data 56. In one exemplary embodiment, at least some of the users U (typically those operating at the scene, e.g., user A, user B, and user C) are uniquely identified with a personnel identifier. In one example, this personnel identifier may be located on the radio frequency identification tag 74 of the user U. Along with this personnel identifier, the personnel data 42 may include: first name data, middle name data, last name data, user name data, rank data, position data, company identifier data, seat number data, primary group assignment data, primary branch assignment data, and/or primary sector arrangement data. The equipment data 44 may include information or data regarding or directed to any of the equipment worn by the user U, or otherwise located or locatable at the scene. The wireless-enabled device data 46 may include information or data regarding any of the equipment worn by the user U, or otherwise located or locatable at the scene that utilizes a wireless architecture (whether short-range or long-range) as its primary means of communication.

The alarm device data 48 may include information and data relating to any alarm devices 75 and/or sensors 68 worn by or associated with the user. Similarly, the alarm data 56 refers to information and data provided by the alarm device 75, or any other device or equipment capable of providing alarm information to or within the system 10. In one example, the alarm device 75 is a personal alert safety system (PASS) alarm device, which normally provides a locally-audible alarm that signals users U in the proximity of the alarm that the person wearing the device 75 requires assistance or rescue. This PASS alarm device may also be a wireless-enabled device, such that it is programmed, configured, or adapted to notify one or more of the interface users U about the local conditions of the user U.

Further, the alarm data 56 and/or the status data 54 may include information or data regarding the status of the alarm devices 75 and/or the user U associated with the alarm device 75. In one example, and as discussed hereinafter, the interface user U can provide an automated notification to all field users U to leave their position (or physical work zone), and seek the safety of a lower-risk area or work zone. This is often referred to as an evacuation (EVAC) notification, and various methods to implement this action include voice communications and audible warning devices, e.g., air horns, sirens, and the like. This EVAC notification or signal may preferably sent at any level of or in the user U hierarchy. Further, this alarm data 56 and/or status data 54 may include manual alarm data, automatic alarm data, evacuation data, and/or battery status data. Finally, the SCBA data 50 includes information and data regarding or directed to the SCBA 70, including its state and operating conditions. For example, the SCBA data 50 may include breathing pressure data, breathing time remaining data, end-of-service time indicator data, battery status data, and temperature data.

As discussed above in connection with the preferred and non-limiting embodiment of FIG. 2, each user U is equipped or associated with the personal inertial navigation unit 72. This personal inertial navigation unit 72 preferably includes multiple sensors and at least one controller programmed, configured, or adapted to obtain data from various navigation-related sensors, and generate or serve as the basis for navigation data 52. As is known, these sensors may include one or more accelerometers, gyroscopes, magnetometers, and the like. In addition, these sensors may sense and generate data along multiple axes, such as through using an accelerometer triad, a gyroscope triad, and a magnetometer triad. The controller of the personal inertial navigation unit 72 obtains raw, pre-processed, and/or processed data from the sensors, and uses this data to generate navigation data 52 specific to the user U in the user's U navigation frame of reference. This navigation data 52 may include: location data, activity data, standing position data, walking position data, jogging position data, running position data, kneeling position data, prone position data, supine position data, lay position (left side) data, lay position (right side) data, crawling position data, rappel position data, azimuth data, total step count data, total distance travel data, and/or battery status data.

As discussed above, the central controller 12 and/or the user computer 62 are programmed, configured, or adapted to receive, process, and/or transmit global resource data 14, including, but not limited to, structure data 18, environment data 20, scene data 22, geographic data 24, computer-aided dispatch data 26, municipal data 28, government data 30, standards data 32, tag data 36, weather data 38, and/or aid data 40. The structure data 18 refers to information and data regarding the structures or buildings that are involved in the incident. Further, the structure data 18 may include three-dimensional structure data, light detection data, ranging data, photogrammetry data, crowded-sourced data, or data specifically generated by or provided by a data resource 58 or user U. The geographic data 24 is directed to information and data regarding geographical information system input and output, and may include base map data, population data, real estate map data, tax map data, census map data, map layer data, street name data, and/or water system data.

The computer-aided dispatch data 26 may include information and data from local, remote, proprietary, and/or third-party systems, including data received through a custom data interface or through some other supplied data interface with a data resource 58. The municipal data 28 is directed to information and data regarding municipal agencies and their employees, such as shift data, pre-fire planning data, building inspection data, and occupancy data. Further, the government data 30 relates to information and data regarding governmental agencies, and standards data 32 relates to various standards that are promulgated by these and other agencies. Accordingly, the government data 30 and standards data 32 may include information about the Department of Transportation Emergency Response Guidelines, the National Fire Incident Reporting System, and the National Incident Management System.

The vehicle data 34 refers to information and data regarding the various vehicles (e.g., fire trucks, engines, rescue vehicles, cars, and the like) and other mobile equipment, including vehicles that are utilized at the scene, and further including Automatic Vehicle Location systems. For example, this vehicle data 34 may include global position data, motorized apparatus data, traffic information data, streaming data, street routing data, and the like. The environment data 20 is directed to information and data regarding the environment where the incident is located, or other environmental information that would be useful in managing the incident. For example, this environment data 20 may include information regarding the buildings or structures (e.g., structure data 18), and may also include other unique attributes and conditions in the immediate or remote environment. Similarly, the scene data 22 refers to information and data regarding conditions, occurrences, information, and data relating to the scene of the incident.

The global resource data 14 may also include tag data 36, which is similar to and/or may be duplicative of at least a portion of the personnel data 42 of the user U. For example, the tag data 36 includes information and data relating to certain accountability aspects of the system 10, including personnel tag data, initialization data, deployment data, accountability data, and the like. Weather data 38 refers to information and data regarding the weather (including past, current, and projected weather information and patterns) at or near the incident and environment. For example, this weather data 38 may include local weather station data, remote weather data, and the like. Finally, the aid data 40 refers to information data regarding mutual aid information, such as information regarding common response mutual aid for facilitating the accountability of resources that do not have or have lost communication with the central controller 12 and/or system 10.

In another preferred and non-limiting embodiment, and with reference to FIG. 2, the central controller 12 is further programmed, configured, or adapted to receive organizational data 82. In addition, the user interface is programmed, configured, or adapted to display content comprising or based upon at least a portion of the organizational data 82 to the user U (e.g., interface user A, interface user B, interface user C, and interface user D). As discussed, this organizational data 82 includes, but is not limited to, operations data 84, section data 86, branch data 88, division data 90, group data 92 (including sector data or any other group-based or common data), and/or resource data 94 (including company data, personnel data, vehicle data, equipment data, and the like). This organizational data 82 provides all users U with information about the personnel and equipment on or at the scene, as well as the roles (e.g., duties, responsibilities, authorization and command levels, and the like) of the personnel.

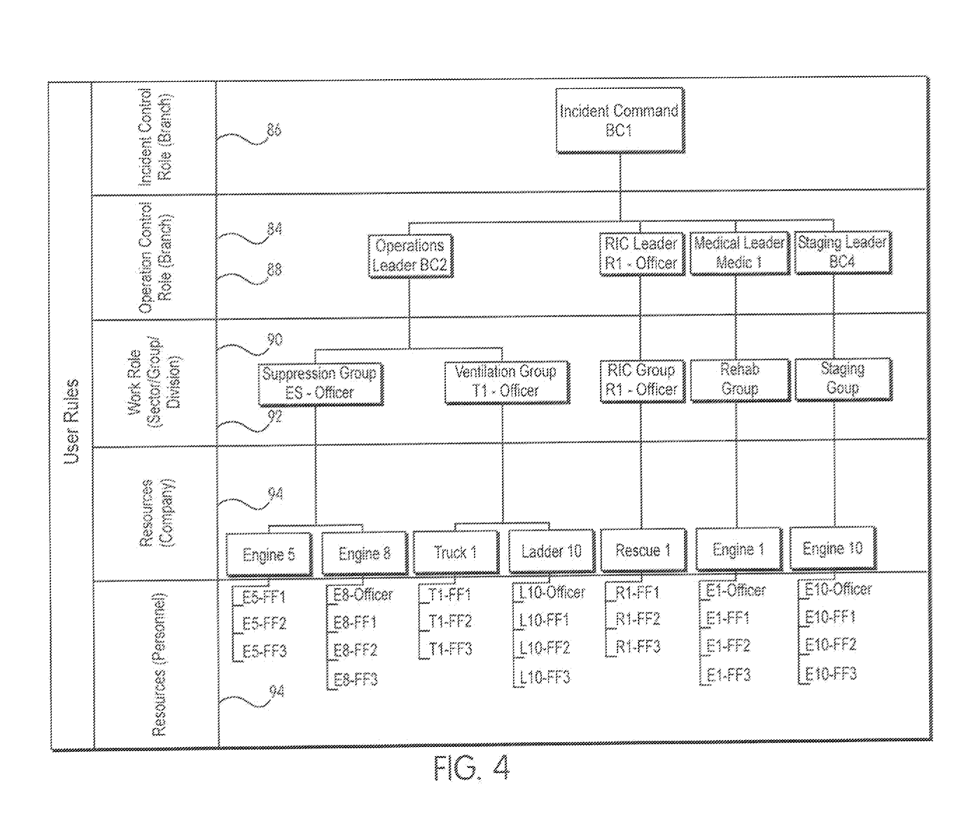

One exemplary organizational structure that can be used to manage an incident is illustrated in FIG. 4. In this preferred and non-limiting embodiment, the organizational data 82 is directed to the identification of and data supporting the various roles of the resources, whether personnel, vehicles, and/or equipment. As shown in FIG. 4, the section data 86 includes information and data referring to incident command personnel, while the operations data 84 and/or the branch data 88 includes information or data relating to the operations leader, the rapid intervention crew leader, the medical leader, and the staging leader. The division data 90, branch data 88, and/or the group data 92 may include information and data referring to the work role level of the organizational structure, including sector data, the suppression group officer, the ventilation group officer, the rapid intervention crew group officer, the rehabilitation group, and the staging group.

As further illustrated in FIG. 4, the resource data 94 refers or relates to information and data at the company level and the personnel level. At the company level, the resource data 94 includes information and data regarding the engine, truck, and/or rescue vehicle deployed or capable of being deployed at the scene. At the personnel level, the resource data 94 includes information and data regarding the various users U that are deployed or capable of being utilized at the scene, such as officers, firefighters, rescue workers, and the like. This organizational data 82 facilitates the command and control aspects of the system 10 by defining duties, responsibilities, activities, tasks, and reporting lines for the appropriate management of the incident.

Generally, the organizational data 82 supports the functions and roles used to manage the scene, e.g., the fire ground. By using this organizational data 82, the system 10 facilitates the support of activities and actions required to manage the action and safety of all personnel. As discussed, certain major organizational components include the sections, the branches, the divisions, the sectors, the groups, and the resources (including companies and personnel). In one exemplary embodiment, the section refers to a collection of branches, where the incident command system section is responsible for all tactical incident operations and implementation of the incident action plan. In the incident command system, the operations section normally includes all subordinate branches, divisions, and/or groups. An incident commander is at the top of the section hierarchy, and this incident commander has access to all information and data generated at the scene at the user interface 100, which provides a total operational picture.

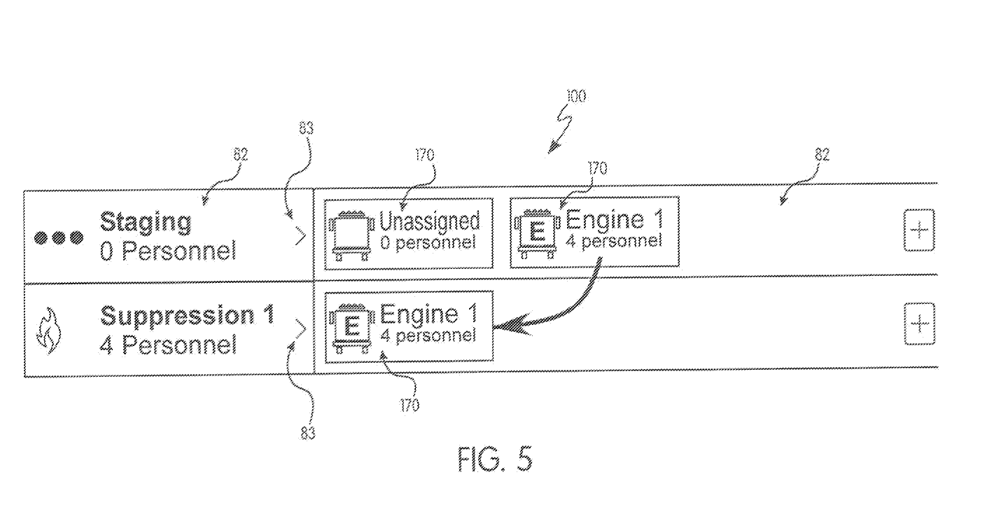

Next, in this exemplary embodiment, the branch is a collection of groups (and/or divisions, sectors, and the like), and this organizational level has functional, geographical, and/or jurisdictional responsibility for major parts of the incident operations. The branch level is organizationally between the section and the division/group in the operations sections, and further between the section and units in the logistics section. For example, the branch level includes operations command (branch chief), the incident safety officer, the accountability officer, the air management officer, the rehabilitation officer, the medical command officer, and the staging area manager. These personnel also have certain access to and control of information and data at the user interface 100. This role level permits the branch leader to act on personnel under their own branch, and adjacent supporting branches. The operations branch is permitted to move personnel through the work cycle. For example, and as illustrated in FIG. 5, using the user interface 100 (in a work assignment function), Engine 1 (company) is assigned to Suppression 1 (group) from Staging (group). The resulting action is supported through voice communication or action of the user interface 100 prompts (e.g., interface data 64) to permit the staging officer (branch) to move Engine 1 through the work cycle.

The group is a collection of companies, and the term “group” is a known designator used by the U.S. fire service to define tactical-level management positions in the command organization. It is also noted that a “group” may also be designated as a division, branch, sector, and the like. In this example, groups are split into two categories—functional (group data 92) and geographical (division data 90). Examples include geographic responsibilities, such as Division C (the rear of the facility) or functional (job) responsibility, such as the suppression group, the rescue group, the medical group, the ventilation group, and the like. When initial assignments are ordered to incoming resources, the incident commander should begin assigning companies to appropriate group responsibilities, e.g., the assignment function shown in FIG. 5. In the exemplary embodiment of FIG. 5, organizational data 82 is provided on a user interface 100 (as discussed in detail hereinafter). In addition, data area 83 may be provided as a functional icon for use in interacting with the interface 100. In this example, data area 83 is in the form of a colored arrow, where the color is automatically assigned at the creation of the group. For example, the color of data area 83 may be assigned to a specific group or company, or may be dynamically updated to indicate a status of the group or company. As also discussed hereinafter, data area 170 provides a graphical representation (e.g., an icon) that is unique to the type of group or type of apparatus (e.g., vehicle or device) associated with that specific group or type of group. Examples of functional groups include staging, suppression 1, suppression 2, backup 1, backup 2, search 1, search 2, ventilation, rapid intervention crew, medical, extrication, exposure A, exposure B, exposure C, exposure D, mutual aid, salvage and overhaul, rehabilitation, none, and undetermined. Examples of geographical groups include division A, division B, division C, division D, division 1 (top floor), and sub-division 1 (lowest basement).

The company is a collection of personnel, vehicles and/or equipment, i.e., resources. For example, the company may refer to a singular resource, with the initial company as unassigned. The company normally describes the collection of personnel (e.g., engine companies), trucks (e.g., ladder trucks), rescue squads, and certain other types of specialized collections of resources. Company designations allow the incident commander to view the collection of personnel or vehicles as a single resource. This approach represents an efficient mode of resource management that is useful in connection with fire ground management activities.

The system 10 and user interface 100 of the present invention provides highly flexible and adaptable methods and processes to automatically and manually organize, manage, and monitor all aspects of the incident. In one preferred and non-limiting embodiment, the system 10 and user interface 100 of the present invention leverage the hierarchical structure of the fire service incident command methodologies, which allows for the natural management of complex incidents and support expansion of the Incident Command structure as an incident grows and/or develops.

Tactical components represent some of the beneficial functionality of the user interface 100 and the system 10 as a whole. Tactically, the incident commander is concerned with execution of the Incident Action Plan (IAP). The IAP provides the defined strategies to mitigate the emergency situation. These strategies may vary as needed and components use may vary depending on the selection of supporting tactics. The work management functionality of the system 10 refers to the assignment of resources to fire ground tasks and activities. These assignments may span the entire incident or last for a short duration, and the concepts utilized may be a combination of zoning and work cycles to ensure safety of operating personnel.

In this exemplary embodiment, air management refers to the process of managing the supply of air in the SCBA 70, which provides both air status and air alarms (e.g., SCBA data 50, alarm data 56, and/or alarm device data 48). The central controller 12 facilitates the ability to record the data, and the user interface 100 provides the means to visualize the air supply of all accounted-for personnel. It is also envisioned that any computer associated with the user interface 100 may also serve to record, arrange, and/or modify some or all of the incoming data. The Incident Commander (as an interface user U) utilizes these feeds to monitor and actively manage force deployment, ensuring the safety of all personnel (i.e., users U). Particular attention can be focused on personnel engaging in high-risk activities.

In this exemplary embodiment, alarm management is the process of managing the alarms (e.g., alarm data 56 and/or alarm device data 48) communicated or generated by the systems and components. Alarms may originate from the various telemetry feeds, may be locally generated, and/or may be communicated from various external sources, such as voice or communicated via mix of sources. Location management can provide a three-dimensional, operational picture of all accounted-for personnel at the incident. The interface provides means to accurately locate personnel (users U) relative to respective origins and/or a common origin. This may provide any number of ways to correlate, prioritize, search, and index users U.

Using the system 10 and the user interface 100 of the present invention, and in this preferred and non-limiting embodiment, work zones are established to denote working areas that require specific levels of Personal Protection Equipment (PPE). The Command Personnel (CP) establish the physical zones by defining areas within the user interface 100 (as discussed hereinafter). Organizational zones are defined and transmitted with the user data 16, the interface data 64, and/or defined by various user interface 100 actions. Personnel, companies, or group entities are then selected to operate within defined zones. If a defined entity crosses or is requested to move in to a higher level than assigned, the CP is notified.

Examples of physical work zones include, but are not limited to: (1) Hot—High Risk (e.g., Immediately Dangerous to Life and Health (IDLH), and High level of Personal Protection Equipment (PPE) required); (2) Warm—Medium Risk (e.g., Building collapse zone, and decontamination zone); and (3) Cold—Lowest Risk (e.g., staging area). Examples of organizational work zones include, but are not limited to: (1) Groups (or Branches, Sectors, Divisions, and the like) (e.g., group functional activity, division number (where the number is the numeric floor number above ground), sub-division number (where the number is the numeric floor number below ground), and division area (where the area is a geographic area)); (2) Branches (e.g., where a single central controller 12 represents a single branch organization, or where multiple central controllers 12 represents multiple branch-level organizational structures); and (3) Sections, which represent the overall incident command at large incidents, or where multiple central controllers 12 represent a system with a potential for multiple branch leaders requiring a dedicated section leader. In this exemplary embodiment, and in terms of air management, alarm management, and work management, work zones provide a means to prioritize air status and alarms, activities, and locations. Higher risk activities take priority, and the user interface 100 provides the functionality to highlight these personnel.

Continuing with this preferred and non-limiting embodiment, work cycles provide the ability to determine and measure the user's time to operate in high risk Warm and Hot Zones. The work cycle may be determined by a number of methods, including “personnel captured” and “estimated”. The “personnel captured” method includes: (1) Baseline (e.g., SCBA activated and pressure transmitted); (2) At-Work Location (e.g., SCBA user notifies incident command at work location, including electronic transmission (automatic) and voice transmission (manual)); and (3) Leave-Work Location (e.g., SCBA user notifies incident command leaving work location, including electronic transmission (automatic) and voice transmission (manual)). The “estimated” method includes: (1) Baseline (e.g., SCBA activated and pressure transmitted); (2) group assignment made; (3) location provides notice zone threshold crossed; and (4) work time projected by using available sensor data (e.g., current SCBA air pressure, current SCBA time of air remaining, proximity to hazard waypoints, and current group assignment).

In this preferred and non-limiting embodiment, the function of work assignment can be implemented at the user interface 100. Normally, the primary work assignment is personnel to a company. One method to obtain this information is in the form of global resource data 14, e.g., tag data 36, user data 16, and/or personnel data 42. For example, the work assignment may occur when the personnel data 42, containing the assignment, is read and stored from the radio frequency identification tag 74 of the user U by the central controller 12 (and available for use at the user interface 100). Another method that may be used is manual assignment by the interface user U through the user interface 100, such that the assignment is part of the interface data 64.

In this embodiment, once a company assignment is registered, companies may be assigned to pre-defined or Command Personnel (CP)-defined groups. Groups represent a form of a work zone based on organizational data 82. The organizational structure, such as the structure of FIG. 4, provides the means to assign companies to functional tasks or geographic locations. Additional organizational structure may take the form of branches and sections as the system grows. Assignments may follow the work cycle needs (e.g., staging, tactical deployment (tasks), and rehabilitation) that support the Incident Action Plan (IAP) and actual events of the incident.

The user interface 100 may be used (by an interface user U) to declare an emergency or mayday. Alternatively, the emergency or mayday may be declared through voice communication. In such an event, the work zones and work assignments assist the Command Personnel (CP) with development of an action plan to mitigate the emergency or mayday. Tools may include, but are not limited to, locating and notifying the nearest company of the event, activating the Rapid Intervention Crew (RIC), and/or guiding the at-risk personnel/company to safety.

The user interface 100 provides the interface users U, such as the Command Personnel, with a continuous data feed allowing for Continuous—Personnel Accountability Reports (C-PAR). C-PAR supplements or replaces the need for manual PAR checks through voice communications. This action is supported by the use of various data streams in the system 10, e.g., global resource data 14, user data 16, and/or organizational data 82, such as work cycles, work zones, and work assignments.

In another preferred and non-limiting embodiment, the organizational data 82 can be used to filter the data displayed to each interface user U (or group of similar interface users U) by providing or assigning authorization levels. Similarly, interaction and creation of interface data 64 (which can affect other actions within the system 10) can be limited or controlled by using the same or different authorization levels. In short, both the data the interface user U can view, as well as the ability of the interface user U to modify or interact with the data, can be controlled within the system 10 of the present invention.

In one preferred and non-limiting embodiment, multiple central controllers 12 and multiple user computers 62 are used to manage the incident and support assignment and distribution of incident command activities. Accordingly, each user interface 100 can be configured to support a defined incident command role, where these roles define the command hierarchy level (thus defining the data interaction permitted by any particular interface user U). The use of such a distributive architecture allows for the command levels to be geographically and/or functionally dispersed. Company and personnel transfer through group assignments can be effectively managed by the branch leader or section leader, e.g., the operations commander moving the first-arriving engine company from (fire) suppression to rehabilitation, and the second arriving engine company from staging to (fire) suppression.

In this exemplary embodiment, the section leader is the overall incident commander in charge of all components of the incident. The user interface 100 provides the section leader with the ability to manage all resources, e.g., personnel, engaged in operational branch activities and adjacent support branches, such as, but not limited to, medical, staging, and rapid-intervention. By assigning roles to the interface users U, the system 10 provides specified interface users U with the capability to manage and monitor all branches, groups, and personnel at an incident. In this embodiment, the branch leaders provide management to the working units (groups). The user interface 100 allows the branch leader to forecast work cycles, forecast personnel needs, calculate “point-of-no-return” factors, and manage time-to-exit factors. The user interface 100 also provides the ability to monitor available personnel in adjacent branches to ensure work management and work cycles are sustainable. Finally, and continuing with this exemplary embodiment, the group leaders represent the point contact for work groups performing specific incident functions assigned by the branch leader. Group leaders may monitor the status of personnel within their given group, as well as all other groups within the branch. This functionality supports active group, company, and personnel monitoring of air and alarms.

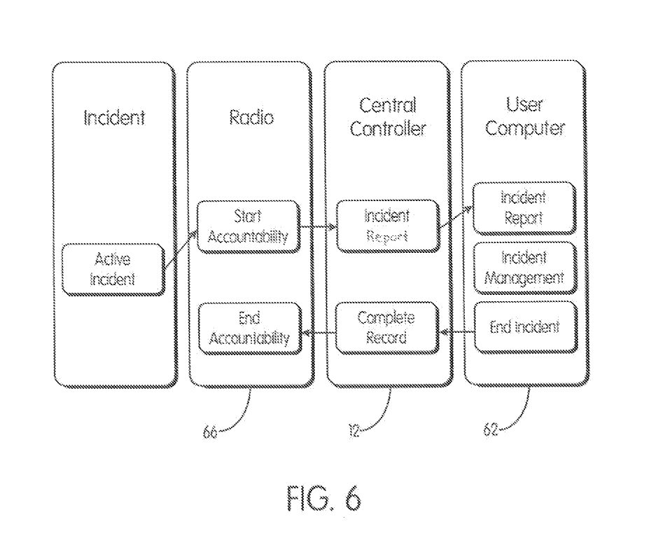

In a further preferred and non-limiting embodiment, and as illustrated in FIG. 6, all incident activities (e.g., data flow) are captured at the start of an active incident. An incident may be started through various methods, including a signal from an external source, such as a computer aided dispatch, global positioning, or other significant incident event. If external signals are not present, a system event of the first active personal controller, e.g., the radio 66, caused by manual activation, pressurization of the SCBA 70, initialization of a personal inertial navigation unit 72, and the like, can signify the start of an active incident.

With the start of an active incident, the accountability functionality of the presently-invented system 10 is activated. The central controller 12 captures and logs some or all of the global resource data 14 and user data 16 provided thereto. If the system 10 utilizes multiple central controllers 12, the global resource data 14, the user data 16, and/or the organizational data 82 can be distributed to, stored at, and/or resolved between these multiple, networked central controllers 12. In this embodiment of the system 10, and upon connection of the first user computer 62 (normally the incident command computer (ICC)), the user interface 100 creates an incident report.

This incident report includes data concerning assignment of work zones (physical and/or organizational) for distribution through the central controllers 12 to all of the connected user computers 62 and user interfaces 100. For example, this data can include user data 16, such as data derived from the user's radio frequency identification tag 74, the user's radio 66, and the like. The user data 16 and/or the organizational data 82 can define the hierarchical relationships between users U and/or interface users U to support the organizational structure. This important information (e.g., global resource data 14, user data 16, organizational data 82, interface data 64, input data 78, output data 80, and the like) can be dynamically and efficiently communicated throughout the system 10 using the central controller 12 as the storage and/or distribution system. For example, if an interface user U makes a modification to a group or user's assignment or task, this information is quickly communicated from the user computer 62 through the central controller 12 and to the user U, such as through the user's radio 66. It is further noted that the radio frequency identification tags 74 can be programmed via supporting administrative software. Upon completion of an incident report, some or all of the global resource data 14 and/or user data 16 data may be downloaded to a central repository and correlated with device data logs, printed to paper records, and/or exported to a supporting system, such as a Fire Incident Records Management System.

The user interface 100 is configured, programmed, or adapted to playback all or a portion of the incident report. This facilitates the review of captured actions and supports view manipulation of the three-dimensional tactical map. It is envisioned that the incident report cannot be modified after the record is complete without specified user authorization. Further, the user interface 100 supports operation through a simulated global resource data 14, user data 16, and/or organizational data 82 feed. While using simulated user data 16 feeds, the data appears the same as data coming from radios 66, and the user interface 100 allows for interacting with and manipulating the data. The simulated session can be captured and played back in a manner similar to live incidents.

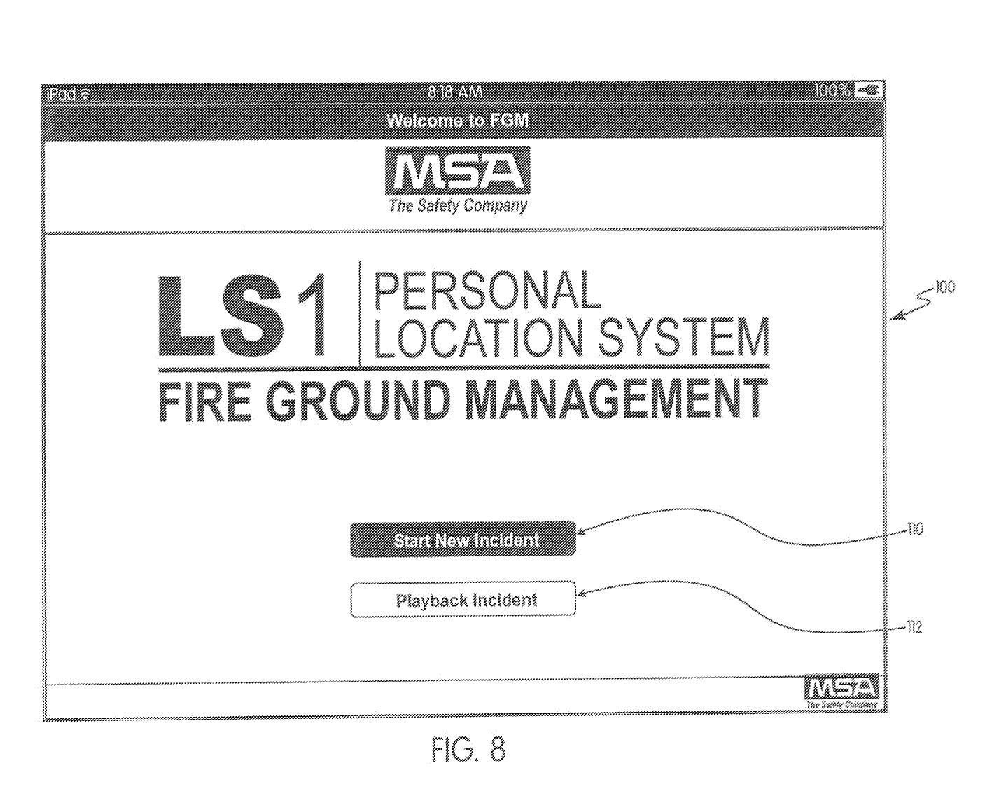

In one preferred and non-limiting embodiment, and as illustrated in schematic folin in FIG. 7, provided is a user interface 100 for incident management and monitoring, and this user interface 100 is configured, programmed, or adapted for implementation on the user computer 62 (or other computing device in communication with or connected to the central controller 12). As discussed, the user computer 62 is programmed, configured, or adapted to: receive data from the central controller 12; transmit data based at least in part upon interface user U interaction with the user interface 100; and generate content for display to the interface user U. As further illustrated in FIG. 7, some or all of this content may include: (i) at least one primary data area 102 displayed in at least one primary data section 104; and (ii) at least one secondary data area 106 displayed in at least one secondary data section 108. The at least one secondary data area 106 is associated with at least one primary data area 102, and based upon user input (e.g., interface data 64), the association between the at least one secondary data area 106 and the at least one primary data area 102 can be modified, configured, generated, and the like. In a further preferred and non-limiting embodiment, the primary data section 104 and/or the secondary data section 108 includes or is associated with a summary/control section 109, which may also display primary data areas 102, secondary data areas 106, and/or other data areas or control data areas (for controlling one or more functions on the user interface 100).

It is envisioned that any of the data, e.g., the global resource data 14, the user data 16, and/or the organizational data 82 represent a primary data area 102 and/or a secondary data area 106 and can be displayed, modified, manipulated, stored, received, transmitted, and/or processed in any of the primary data section 104, the secondary data section 106, and/or the summary/control data section 109. In particular, the presently-invented system 10 and method provides numerous data streams for display and use at the user interface 100, and some or all of these data streams can be used to make appropriate management and control decisions at the scene during the incident. Accordingly, the presently-invented system 10 and user interface 100 provide a comprehensive management tool that receives, processes, distributes, and contextualizes a multitude of data streams for incident command and control environments.

In one preferred and non-limiting embodiment, the primary data section 104, the secondary data section 108, and/or the summary/control data section 109 facilitate the generation, configuration, and/or display of global resource data 14, user data 16, organizational data 82, work zone data, work cycle data, work assignment data, work control data, accountability data, and/or role data, including data derived from or through the organizational data 82 and/or interface data 64. In another preferred and non-limiting embodiment, the primary data section 104, the secondary data section 108, and/or the summary/control data section 109 facilitate the generation, configuration, and/or display of global resource data 14, user data 16, self contained breathing apparatus data 50, air data, air status data 54, and/or air alarm data 56. In a further preferred and non-limiting embodiment, the primary data section 104, the secondary data section 108, and/or the summary/control data section 109 facilitate the generation, configuration, and/or display of global resource data 14, user data 16, and/or alarm data 56. In a still further preferred and non-limiting embodiment, the primary data section 104, the secondary data section 108, and/or the summary/control data section 109 facilitate the generation, configuration, and/or display of global resource data 14, user data 16, navigation data 52, and/or visual data. In another preferred and non-limiting embodiment, the primary data section 104 and/or the secondary data section 108 provide a visual representation of at least one environment in which at least one user U is navigating. Further, this visual representation of the at least one environment is user-configurable.

As discussed above, the user interface 100 can take a variety of forms, but preferably provides the interface user U with content, data, and/or information either in its raw or processed form. For example, the user interface 100 may display content that is communicated directly or indirectly from: a data resource 58, a user's equipment or associated components, vehicles or other equipment located at the scene, the central controller 12, other user computers 62, and/or other data-generating components of or within the system 10. Further, this content may be simply displayed, or processed or reformatted for presentation at the user interface 100, whether in the primary data section 104, the secondary data section 108, and/or the summary/control data section 109. Still further, this content may be interactive and dynamically modified based upon interface user U interaction, thereby creating interface data 64 (which can serve as content for the central controller 12 and/or other user computers 62). Accordingly, the content of the user interface 100 may include: some or all of the global resource data 14; some or all of the user data 16, some or all of the organizational data 82, at least one selectable element, at least one configurable element, at least one control element, at least one user input area, visual data, and/or processed data. In this manner, the user interface 100 of the present invention facilitates interaction by and communication between the interface users U and/or the user U navigating or present at the scene. This, in turn, provides an effective monitoring and management system 10 for use at the scene of an incident.

In addition, the various screens or pages of the user interface 100 can be formatted or configured by an interface user U and/or an administrative user. As also discussed above, the content and permitted modification can be filtered based upon the authorization level of the interface user U. Still further, the content displayed at the user interface can be substituted by or augmented with audio data, such as alarms, digital voice or sound data, analog voice or sound data, recorded audio data, and the like. For example, the voice communications by and between the interface users U and/or the user U present or navigating at the scene can be recorded and synchronized with some or all of the incoming data.

As used hereinafter, the term “data area” refers to generated and/or displayed data or content, a data element, a selectable element, a configurable element, a control element, an input area, visual data, and/or processed data. One or more of the “data areas” may have some functionality at or within the user interface 100 and/or the system 10. Further, the “data area” may be a primary data area 102, a secondary data area 106, and/or any data area or control data area generated and/or provided at the user interface 100. Still further, these “data areas” may be generated and updated dynamically or on some specified basis.

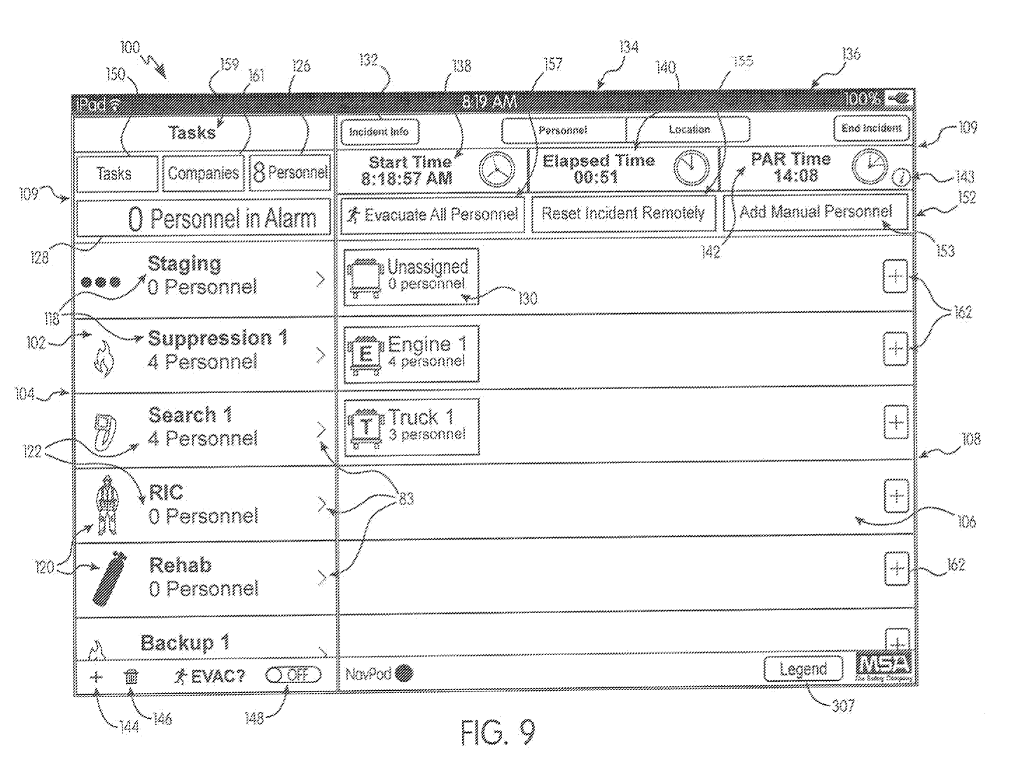

One preferred and non-limiting embodiment of the user interface 100 and various portions thereof according to the present invention is shown (in “screenshot” or graphical form) in FIGS. 8-41. With specific reference to FIG. 8, the home page or screen is illustrated, and the interface user U has the option to either “Start New Incident” (data area 110) or “Playback Incident” (data area 112). Data area 110 is used to create a new incident at the user interface 100, such that the appropriate data structures are initiated and utilized. Data area 112 moves the interface user U to another section of the user interface 100 for playing back an incident that has already occurred. Further, and optionally, a “Connection Status” may be included to provide the interface user U with a positive indication of the status of his or her connection to and with the user interface 100, the system 10, and/or the central controller 12.

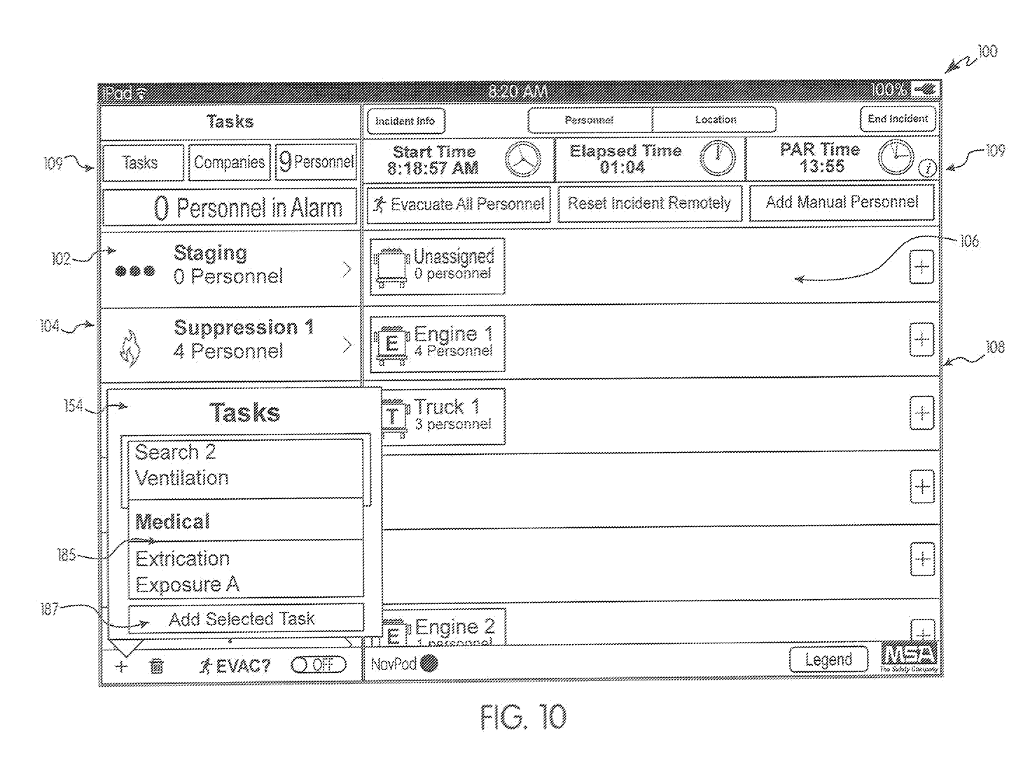

As illustrated in FIG. 9, and in this exemplary embodiment, primary data section 104 is in the form of a resource management list, which includes a pane of content and information that represent the selected level of resources or information (e.g., sections, branches, divisions, groups, resources, alarms, global resource data 14, user data 16, vehicles, equipment, and/or personnel) of the incident command structure. Accordingly, primary data section 104 represents a high-level view of the primary data areas 102 that are being reviewed by and/or interacting with the interface user 100. As shown in the preferred and non-limiting embodiment of FIG. 9, which is illustrating work/task assignment (e.g., a work management section) at the group level, the interface user U can be provided with primary data areas 102 including the group name (data area 118), an icon (data area 120) representing the type of group, the number (data area 122) of personnel associated with or assigned to that group, and an activity- or group-specific colored icon (data area 83), such as a “>” symbol, which may also be used to indicate some interface user U interaction with the user interface 100.

In this embodiment, secondary data section 108 is a detailed listing, which includes a pane of content and information (e.g., secondary data areas 106) that represent further details about some or all of the primary data areas 102 provided in the primary data section 104, such that the secondary data section 108 represents a greater level of detail, information, and/or data about the primary data areas 102 in the primary data section 104. Accordingly, the secondary data section 108 represents a detail-level view of some or all of the primary data areas 102 that are being reviewed by and/or are the object of interaction with the interface user U.

In the embodiment of FIG. 9, the secondary data section 108 includes information and data about specific resources, such as the specific company or personnel, associated with or assigned to the group listed in data area 118. In this embodiment, a summary/control data section 109 includes data area 126, which is used to select “all” resources (e.g., companies, equipment, personnel, and the like), and leads to a listing of all resources. Data area 128 is used to select all resources with an “alarm” status, such that it leads to a listing of all resources experiencing an alarm condition. Data area 130 in the secondary data section 108 is used to view, manage, and/or select all unassigned resources (e.g., those at the staging level), and leads to a listing of all resources that have not been assigned to a group, a task, an environment, and the like. Still further, data area 159 is used to display the general title of the section of the user interface 100 in which the interface user U is navigating, e.g., the “Tasks” section of the interface 100. With continued reference to the summary/control data section 109, data areas 150 and 161 are used to indicate, change, and/or navigate to or from the current displayed section or data elements in the primary data section 104 and/or the secondary data section 108, such as from or to the task-based (e.g., “Tasks” data area 151) section and from or to the company-based (e.g., “Companies” data area 161) to another section or portion of the user interface 100.

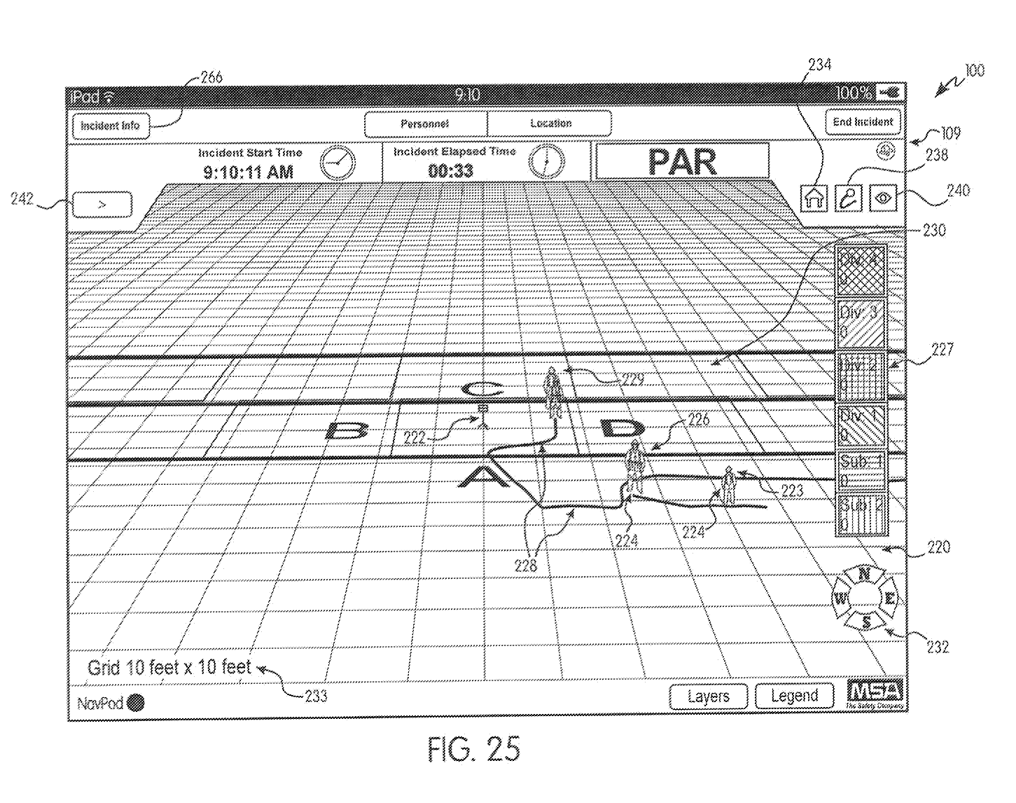

As further illustrated in FIG. 9, and in summary/control data section 109, data area 132 is used to navigate to a listing of data and information related to the incident, and data area 134 provides the options for toggling between the detailed information and data of the resources, e.g., “Personnel” (as shown in FIG. 9), and a tactical map, e.g., “Location” (as discussed hereinafter, and as shown, for example, in FIGS. 25-28). Data area 136 is used to terminate or end the “incident” and proceed with saving certain data streams to the databases, whether on the user computer 62 and/or the central controller 12. The incident start time (data area 138) and the incident elapsed time (data area 140) are provided to the interface user U, and may be accompanied by a visual display of a clock. A personal accountability report (PAR) timer (data area 142) is included, which is also accompanied by a visual display of a clock. Data area 142 provides a reminder to the interface user U to initiate a role call to user U and/or resources in the group under his or her command. This role call can be performed over voice communications (e.g., using the user's radios 66 or similar voice-based systems) or in some automated form through the central controller 12, such as part of the interface data 64 (the “role call”) and the user data 16 (the response to the “role call”). In addition, through the selection of the “i” button (data area 143), the interface user U is provided with a selectable, e.g., slidable, time increment bar (not shown) to adjust when the “role call” should be initiated. While this time increment is normally set to 15 minutes, the interface user U can adjust this increment to any desired amount.

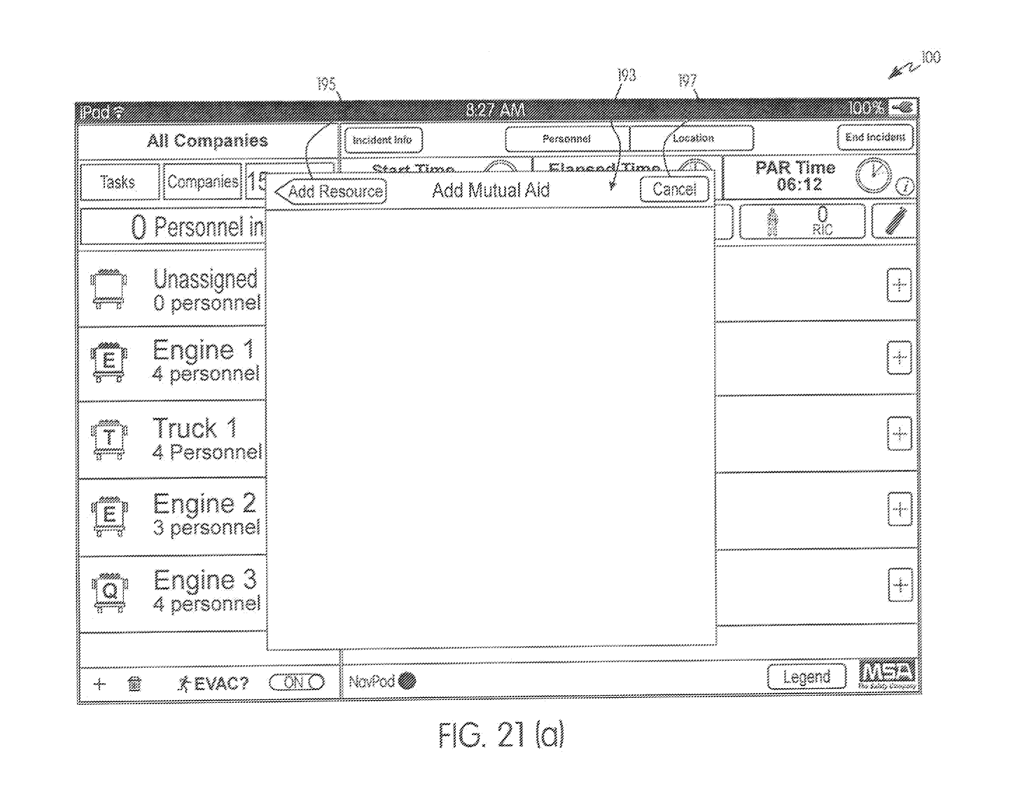

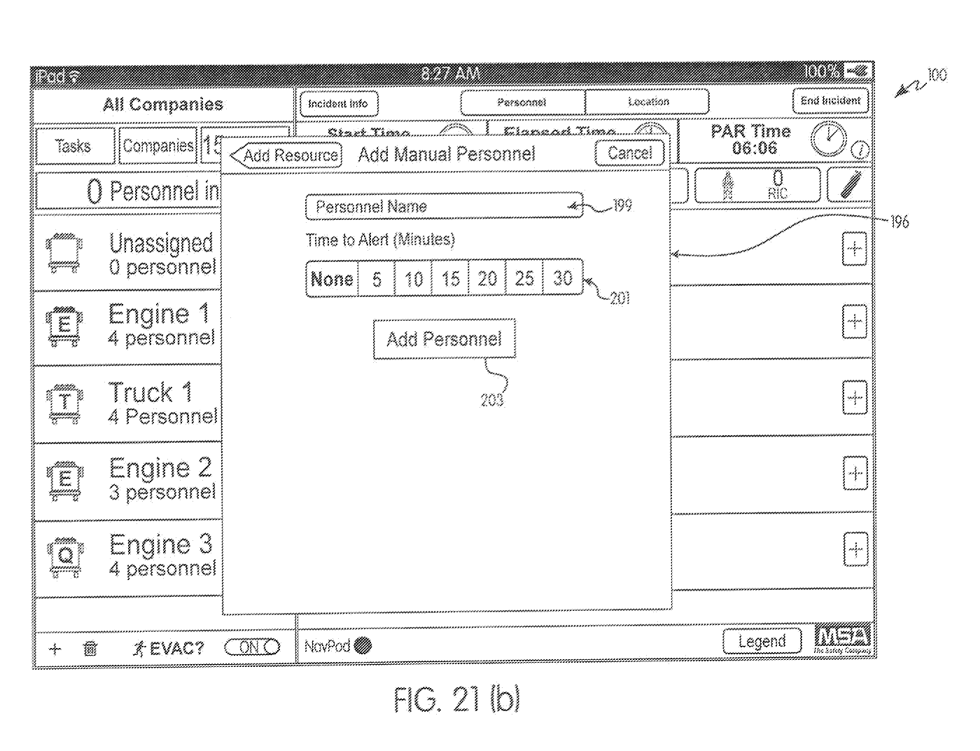

With continued reference to FIG. 9 and within the summary/control data section 109 at this navigational point, data section or area 152 provides additional functional options, in the form of: data area 153 (“Add Manual Personnel”) for navigating to a section to manually add personnel to a group or mutual aid, as shown, for example, in FIGS. 20 and 21(a)-(b); data area 155 (“Reset Incident Remotely”) for permit the interface user U to reset the incident data (or a portion thereof) on the central controller 12 or other areas of the system 10; and data area 157 (“Evacuate All Personnel”), which allows the interface user U to quickly send the command for all personnel to evacuate the scene. Again, these data areas 153, 155, and 157 (corresponding to certain important and/or commonly-used functions) are located in the summary/control data section 109 for prominent display and ease of use to the interface user U.

In this preferred and non-limiting embodiment, and with reference to the primary data section 104, the “+” button (data area 144) is a context-based functional element, that permits the addition of data, e.g., a resource, a group, a company, equipment, personnel, and the like, to whichever data area or portion the interface user U is presently navigating, while the “trash” button (data area 146) is a context-based functional element that permits the deletion of data from whatever data area or portion the interface user U is presently navigating. The “EVAC” button (data area 148) is used to trigger an evacuation communication to a selected group, a selected company, a selected person or user U, and/or any other configurable grouping of equipment or people. In addition, and as with other functionalities of the user interface 100, the evacuation function is contextual and the “evacuation” signal or communication is provided to the persons or groups that are currently displayed or represented in the area of the user interface 100 in which the interface user U is navigating.

In the exemplary embodiment of FIG. 9, primary data section 104 includes the above-discussed group-based listing, such that “groups” represent the primary data areas 102 (or primary data elements). Thus, it can be configured to continually display all groups in the system 10, and their task and/or assignment. By selecting one of these primary data areas 102, e.g., data area 118, 120, 122, 83, the interface user U navigates to a further screen (as discussed hereinafter) that provides additional interactive data about that selected group. As discussed, secondary data section 108 provides a more detailed listing and/or further information (e.g., company information) regarding the primary data areas 102 (groups) listed in primary data section 104. When data area 134 is set to “Personnel”, the interface user U is provided with details about the group to which the company is presently assigned. Thereafter, the interface user U can drag-and-drop resources, e.g., companies, equipment, personnel, and the like) between groups for initiating a change in task and/or assignment, e.g., see FIG. 5.

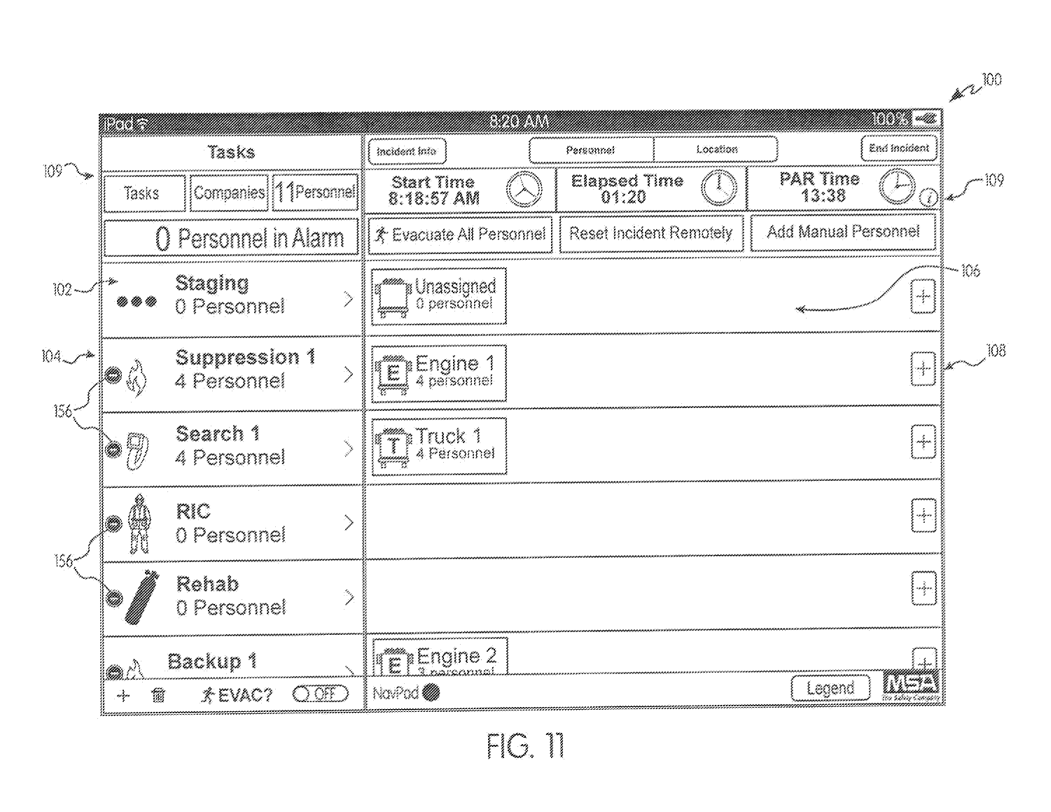

With continued reference to the exemplary embodiment of FIG. 9, selecting data area 144 prompts the interface user U for the addition of a new group (as related to the group “task” assignment), as shown in FIG. 10. In particular, a menu (data area 154) appears as “Tasks” and allows for the selection and addition of a group and/or task to the incident. Data area 185 provides a listing of available groups/tasks that can be individually or collectively added to a selected group, and data area 187 permits the interface user U to type in the name of a “custom” task and add this task to the selected group. Again, it is noted that this addition of a group (whether a group, a task, a company, a resource, and the like) is contextual and dependent on whether the interface user U is navigating in the “Tasks” section (related to data area 150) or the “Companies” section (related to data area 161. In particular, if data area 150 is selected, the primary data section 104 will display groups by tasks (as the primary data areas 102) and the secondary data section 108 will display related groups by companies (as the secondary data areas 106). Similarly, if the data area 161 is selected, the primary data section 104 will display groups by companies (as the primary data areas 102) and the secondary data section 108 will display the related or included personnel (or resources (as the secondary data areas 106). When navigating in the “Companies” section, the selection of data area 144 would lead to a similar menu (data area 154) labeled “Resource Type” for use in adding resources to the company. It is important to note that the selection, addition, deletion, and management of the data elements and groups on the user interface 100 is contextual and based upon the area or section that the interface user U is presently navigating.

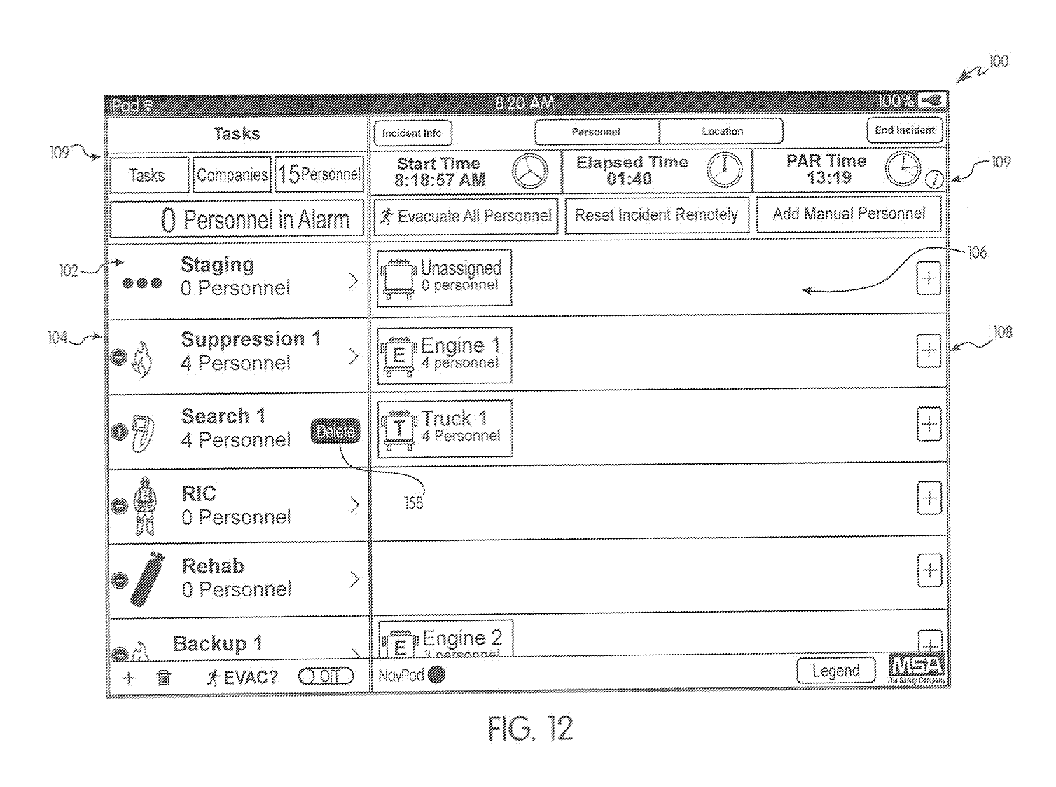

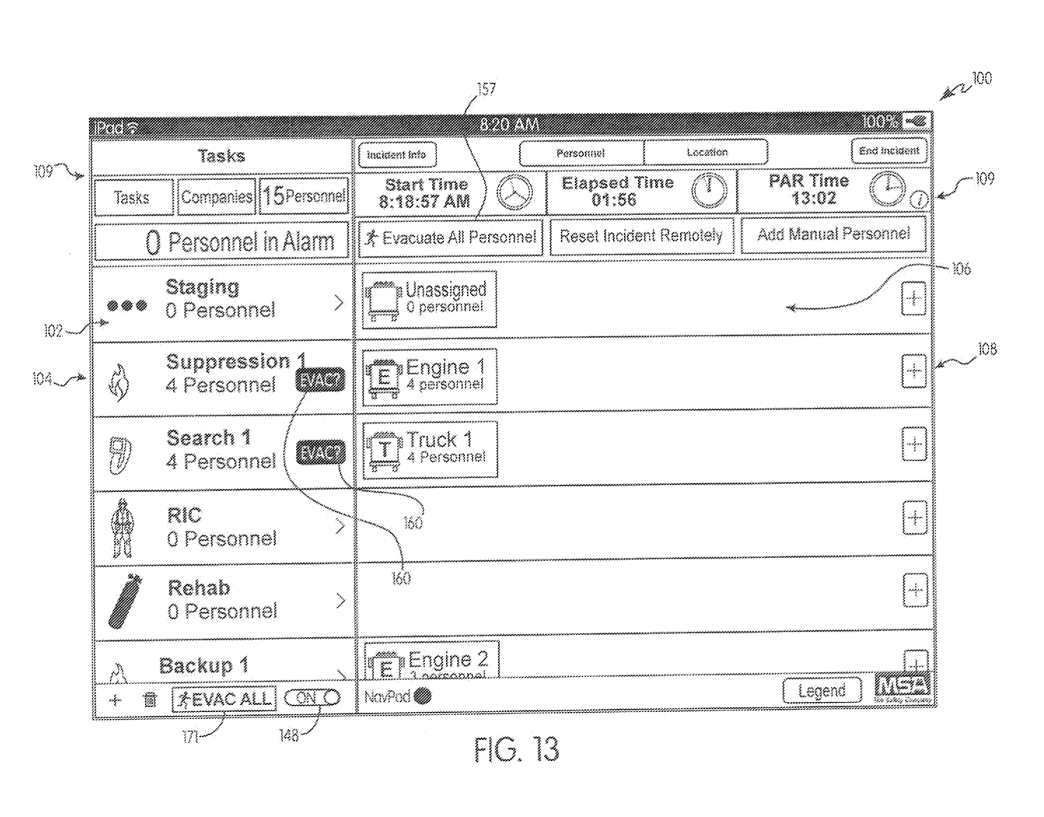

By selecting data area 146, and as illustrated in FIG. 11, the groups (in this embodiment, by task) are listed in primary data section 104, and a “−” button (data area 156) is positioned next to some or all of the groups. The interface user U may then select data area 156 next to the corresponding group that he or she would like to remove. See FIG. 11. After selecting the group for deletion, data area 158 (as shown in FIG. 12) provides a further selectable element to ensure that the interface user U does, indeed, wish to remove this group. It should be noted that this addition/removal functionality can occur for any data area (e.g., group, resource, task, etc.) in the primary data section 104 and/or the secondary data section 108.

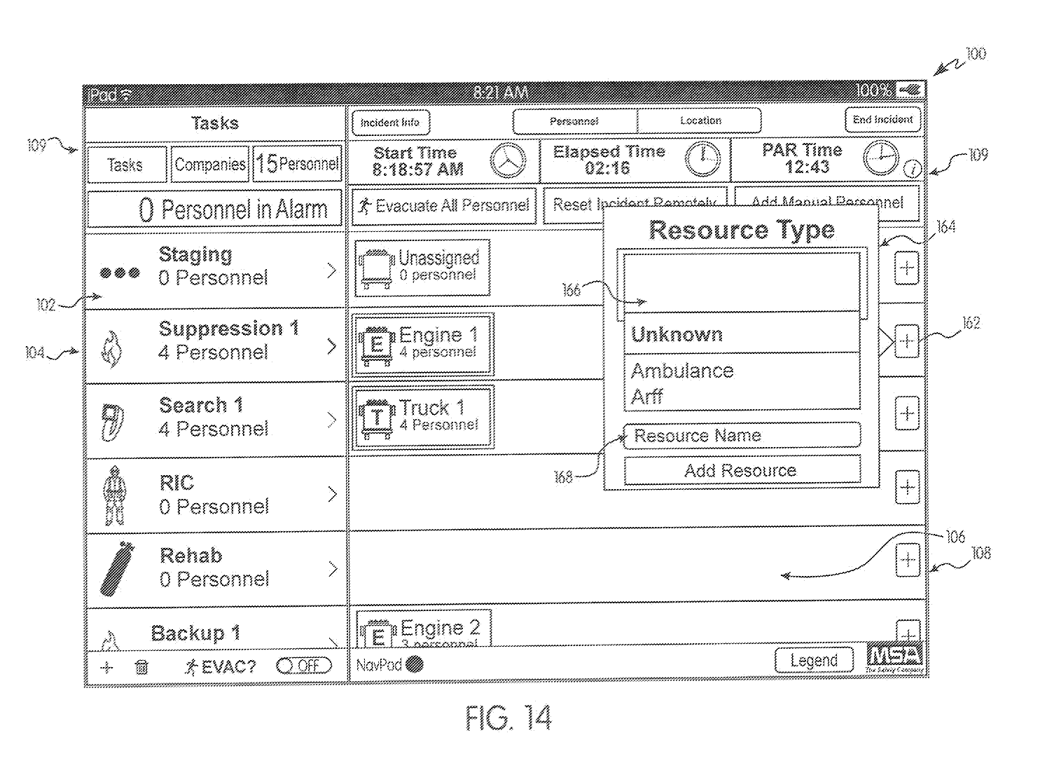

Additionally, when initiating an evacuation via data area 148, the interface user U can select which groups to evacuate, as illustrated in FIG. 13. Of course, it should be recognized that this action can only be initiated with respect to groups and/or companies that have personnel assigned thereto and/or the groups or personnel that is the responsibility of that particular interface user U. Also, as discussed above, this evacuation function can be context based. In operation, the interface user U selects the “EVAC?” data area 160 to confirm that the group and/or company should be evacuated. It is envisioned that the user interface 100 can be operable to facilitate the evacuation of single users U, groups of users U, equipment, companies, sectors, branches, divisions, and the like. For example, as discussed above, all personnel can be evacuated from the scene using data area 157 (as opposed to the targeted evacuation through data areas 148, 160. It is further illustrated in FIG. 13 that when the interface user U interacts with data area 148 (e.g., see FIG. 9), a further data area 171 is provided and used in a similar manner as data area 157, i.e., provides a quick means to evacuate all personnel from the scene.

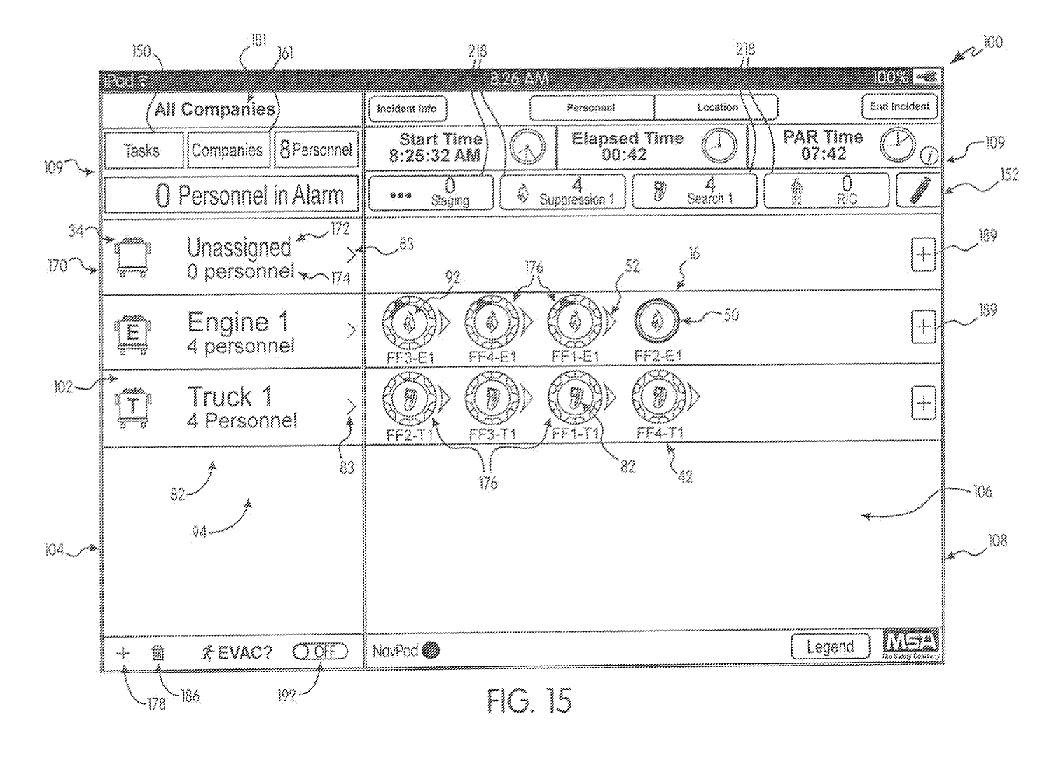

By selecting the “+” button (data area 162) in FIG. 9, the interface user U is prompted to add a company to the group, as shown in FIG. 14. Specifically, data area 164 is displayed to the interface user U, which represents a customizable interface for adding resources, e.g., companies, to the group. Data area 166 provides a listing of available resources that can be individually or collectively added to a selected group, and data area 168 permits the interface user U to type in the name of a “custom” resource and add this “custom” resource to the selected group.

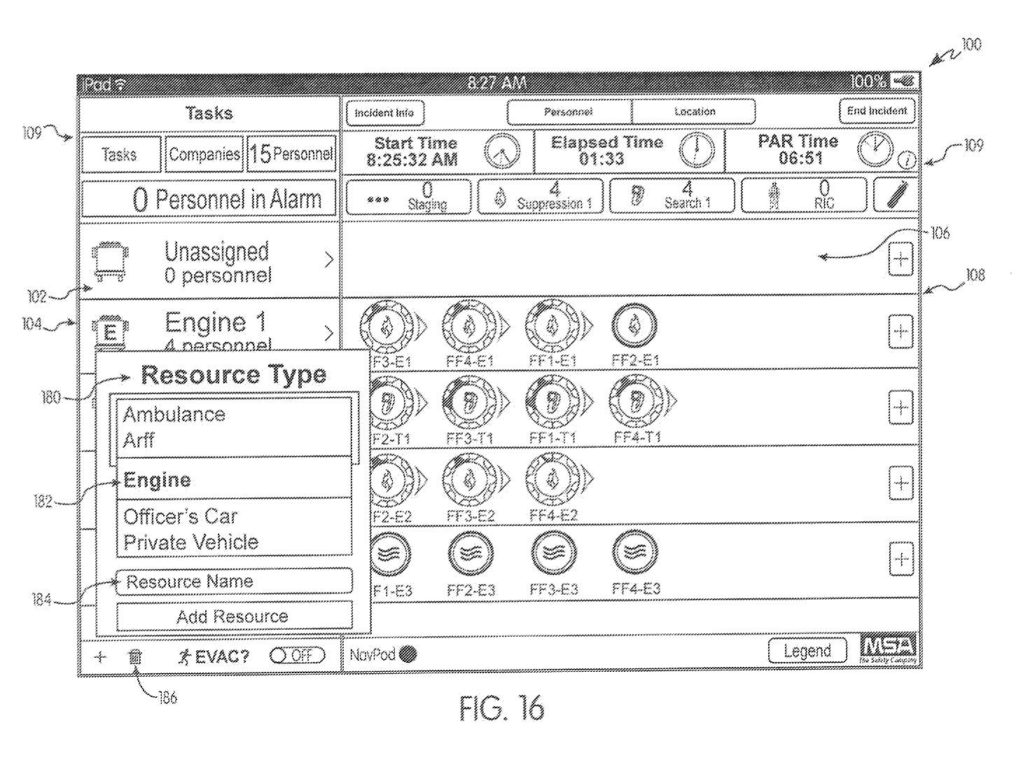

FIG. 15 illustrates the user interface 100 with companies as the primary data areas 102 in primary data section 104, and personnel (with accompanying user data 16) listed in secondary data section 108. In the primary data section 104 of this embodiment, each company is represented in data area 170 in graphical form with associated organizational data 82 and/or resource data 94, including assignment information (data area 172) (e.g., “Unassigned”, “Engine 1”, “Truck 1”, and the like), company personnel information (data area 174) (e.g., the number of personnel in the company), and vehicle data 34 (i.e., a visual representation of the vehicle/company type, which may take a variety of forms to graphically (e.g., icon, color, letter, number, and the like) represent resource information or other functional data or information about data area 170). Further, the companies displayed in the primary data section 104 depend on the group (i.e., group data 92) selected or with which the interface user U is interacting. Therefore, and according to the hierarchical data arrangement of the interface 100, the top-level data element is the group, such that the various companies (i.e., resource data 94) in the group comprise the primary data areas 102 in the primary data section 104, while the personnel (resource data 94 or user data 16) comprise the secondary data areas 106 in the secondary data section 108. If a specific company is then selected by the interface user U, the primary data areas 102 in the primary data section 104 become the personnel, with the secondary data areas 106 in the secondary data section 108 becoming more detailed information and data about each person or user U. See FIG. 21.

The interface user U can change the displayed group, by task, company, group, resource, or the like, using the data areas (e.g., data areas 150, 161) in the summary/control data section 109, and the selected group is highlighted or otherwise indicates selection. For example, the interface user can perform a global change of viewed groups using data element 150 (i.e., tasks) or data element 161 (companies). In the exemplary embodiment of FIG. 15, the interface user U is navigating in the “companies” section (through the selection of data element 161), such that the primary data section 104 displays the companies as the primary data areas 102. Further, when navigating in the “companies” section (as shown in FIG. 15, and entitled “All Companies” (data area 181)), the group (by task) information and data (data elements 218) are shown in data area or section 152 of the summary/control data section 109. By selecting any of these data areas 218, the interface user U is moved to the “tasks” section of the user interface 100, and specifically to the selected group (by task).

In the secondary data section 108 of the embodiment of FIG. 15, each user U (or resource) is represented in data area 176 in graphical form with user data 16, including SCBA data 50 (i.e., a graphical representation of whether the user U is wearing an SCBA 70, and how much air is left in the SCBA 70), organizational data 82 (i.e., a graphical representation of the present group (or work task) to which the user U is assigned), personnel data 42 (in the form of the user's identification number or code), and navigation data 52 (i.e., a graphical representation of the status of the user's personal inertial navigation unit 72). Other information could be provided in data area 176, such as status data 54, alarm data 56, and the like. Still further, the various users U (secondary data areas 106) are aligned with the company (primary data areas 102) to which they are assigned. This provides a quick visual understanding of the distribution of resources, including resource data 94, group data 92, user data 16, organizational data 82, and the like. With continued reference to the preferred and non-limiting embodiment of FIG. 15, the primary data areas 102 further include data area 83, as discussed above.

Of course, this visual (assignment) information and process can be equally applied throughout the interface 100 using the incoming and outgoing organizational data 82, and based upon the interface user U selection. Therefore, some or all of the organizational data 82 (e.g., operations data 84, section data 86, branch data 88, division data 90, group data 92, and/or resource data 94) can be visually presented to the interface user U in an organized and hierarchical manner. Still further, the interface user U can use the interface 100 to modify assignments and tasks from the operations level down to the individual resource level, whether geographically or functionally. For example, in the embodiment of FIG. 15, the interface user U could simply drag-and-drop users U from one company to another to change their individual assignment. This same functionality can be used in connection with assigning and modifying assignments and/or tasks at any level of the hierarchy based upon the interface user U control level. See, e.g., FIG. 5.

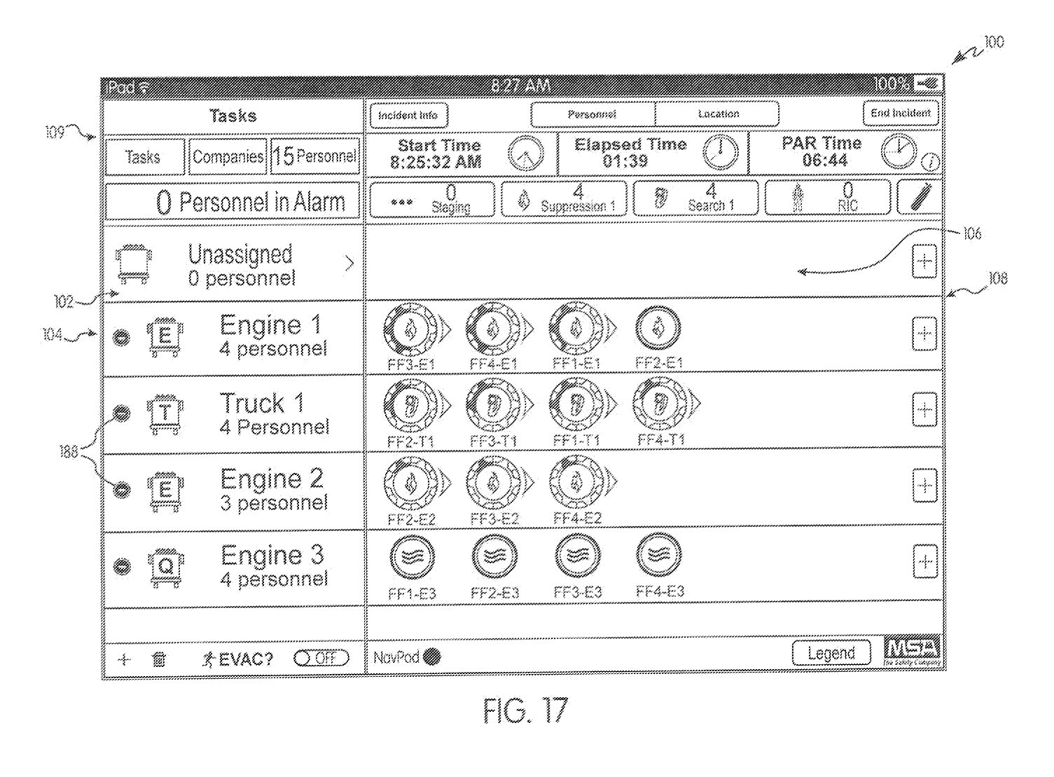

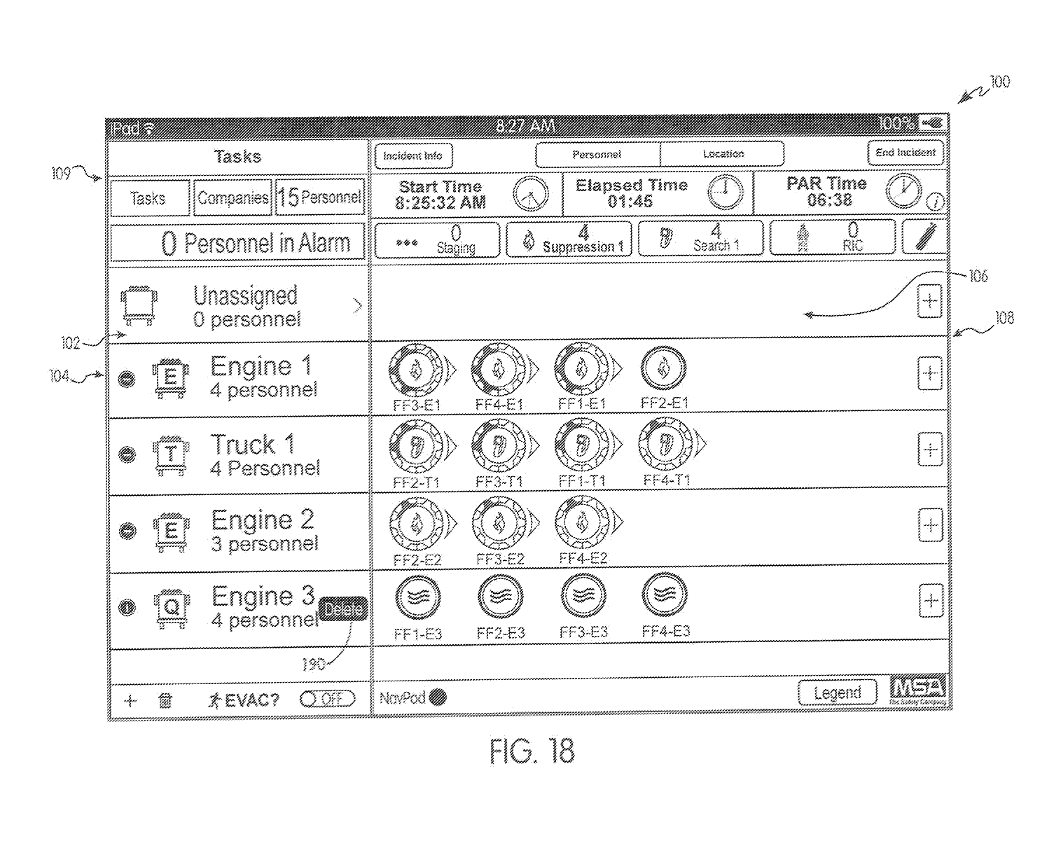

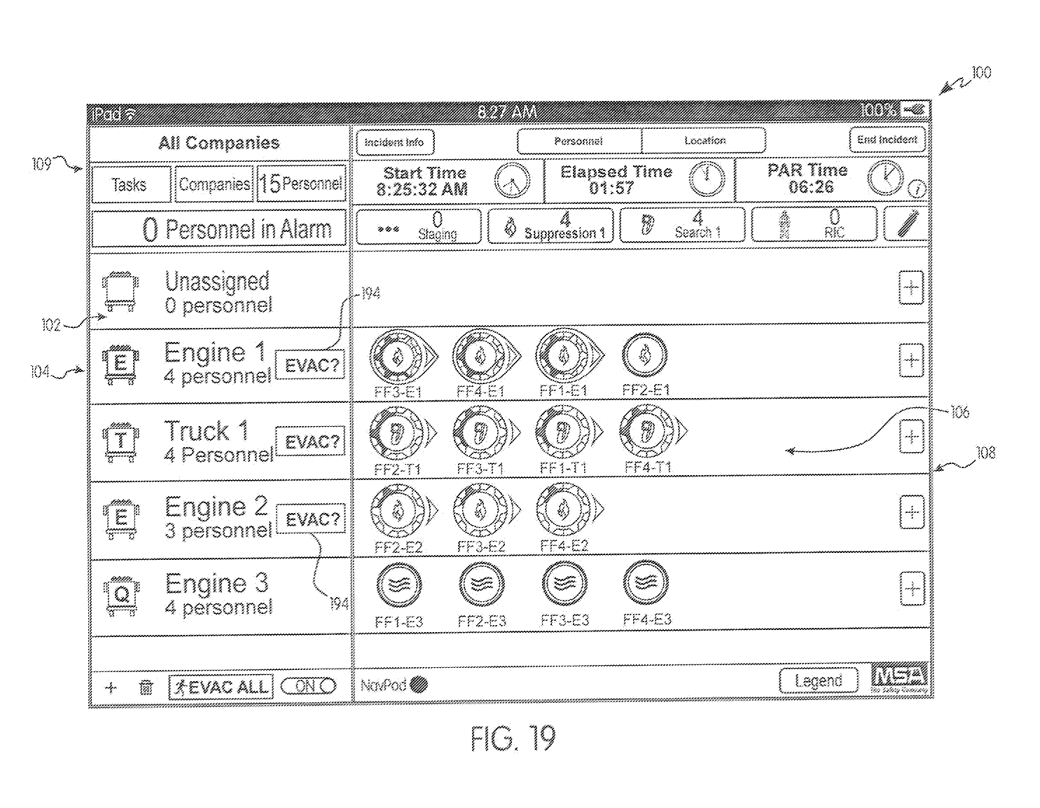

In the preferred and non-limiting embodiment of FIG. 15, by selecting the “+” button (data area 178) in the primary data section 104, the interface user U is prompted to add a company to the group, as shown in FIG. 16. Specifically, and as discussed above, a menu entitled “Resource Type” (data area 180) is displayed to the interface user U, which represents a customizable interface for adding resources, e.g., companies, to the group. Data area 182 provides a listing of available resources that can be individually or collectively added to a selected group, and data area 184 permits the interface user U to type in the name of a “custom” resource and add this resource to the selected group. Also, as discussed above, the “trash” button (data area 186) in FIG. 15 is a context-based functional element that permits the deletion of data from whatever data area or section the interface user U is presently navigating. In this case, data area 186 allows for the deletion of a company. In particular, by selecting data area 186, and as illustrated in FIG. 17, the companies are listed in primary data section 104, and a “−” button (data area 188) is positioned next to some or all of the companies. The interface user U may then select data area 188 next to the corresponding company that he or she would like to remove. After selecting the company for deletion, data area 190 (as shown in FIG. 18) provides a further selectable element to ensure that the interface user U does, indeed, wish to remove this company. In addition, data area 188 may be automatically updated (e.g., reorienting the “−” to a vertical position) to indicate the intended action or action taken.

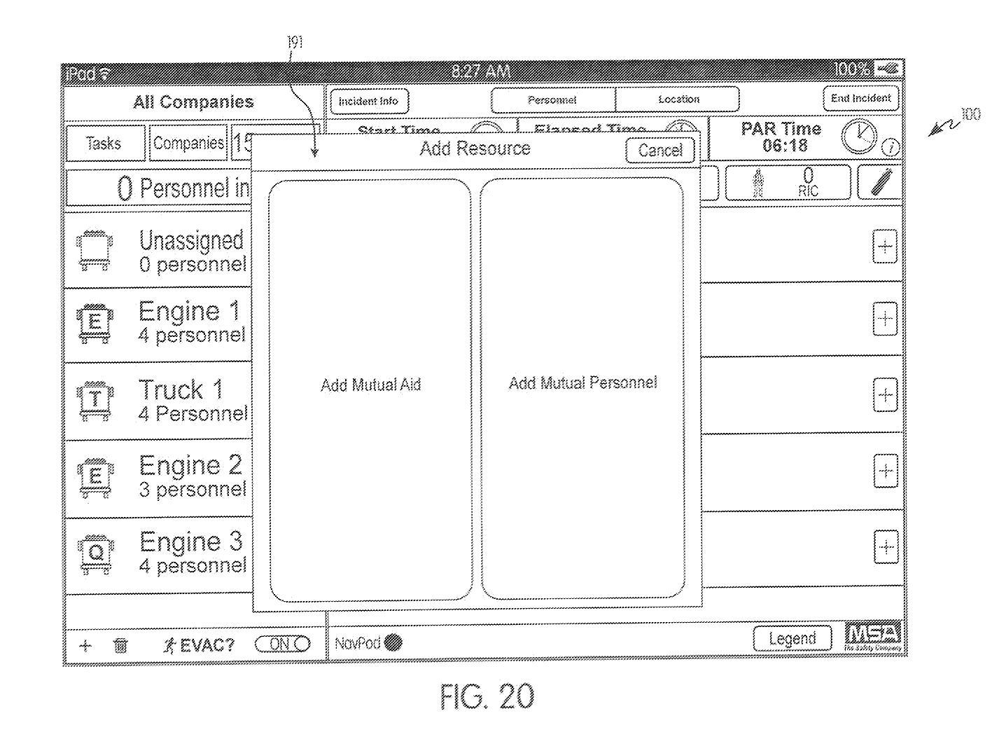

Additionally, and as discussed above, when initiating an evacuation via data area 192 in FIG. 15, the interface user U can select which companies to evacuate, as illustrated in FIG. 19. Again, it should be recognized that this action can only be initiated with respect to companies that have personnel assigned thereto. In operation, the interface user U selects the “EVAC?” data area 194 to confirm that the company should be evacuated.

In the preferred and non-limiting embodiment of FIG. 15, by selecting the “+” button (data area 189) in the secondary data section 108, a menu entitled “Add Resources” (data area 191, as shown in FIG. 20) is displayed to the user to either manually add mutual aid data (as shown in FIG. 21(a)) or personnel (as shown in FIG. 21(b)), where this added resource will be assigned to the company that is aligned with the “+” button (data area 189), as shown in FIG. 15. Specifically, as shown in FIG. 21(a), data area 193 permits the interface user U to add mutual aid resources to the selected company. For example, this mutual aid may be in the form of other personnel, resources, groups, divisions, sections, and the like, and this mutual aid information may relate to data provided by synchronization with other data resources 58. In one exemplary embodiment, the information and data in data area 193 permits the user to select one or a group of personnel based upon the present mutual aid configuration. In addition, data area 193 includes an “Add Resource” button (data area 195) to add a resource (relating to mutual aid) to the provided listing in data area 193, and a “Cancel” button (data area 197) allows the interface user U to navigate back to the main menu (data area 191).

Further, and as shown in FIG. 21(b), data area 196 permits the interface user U to add specific personnel to the selected company or group. In particular, data area 199 allows the interface user U to directly input the person's name, data area 201 is a selectable element to allow the interface user U to select the amount of time before which the added user is considered in alarm, and data area 203 completes (or enters) the added person. Further, data areas 193 and 195 function as discussed above. It is also envisioned that data area 196 will facilitate additional configuration and control over specific personnel at the interface user U level, such as estimated SCBA 70 breath down rate (i.e., time until empty) and other information.

It is further envisioned that data areas 191, 193, and 196 (or any other data entry area of the user interface 100) can include a customizable list of available resources, which are selectable by the interface user U. Further, data areas 191, 193, and 196 (or any other data entry area of the user interface 100) can include a hierarchical arrangement of selectable resources through which the interface user U can navigate. In one example, the data areas 191, 193, and/or 196 may be populated using or in communication with remote data resources 58, from which data can be imported for selection. For example, this other data may include computer aided dispatch data 26, municipal data 28, vehicle data 24, organizational data 82, personnel data 42, and the like.

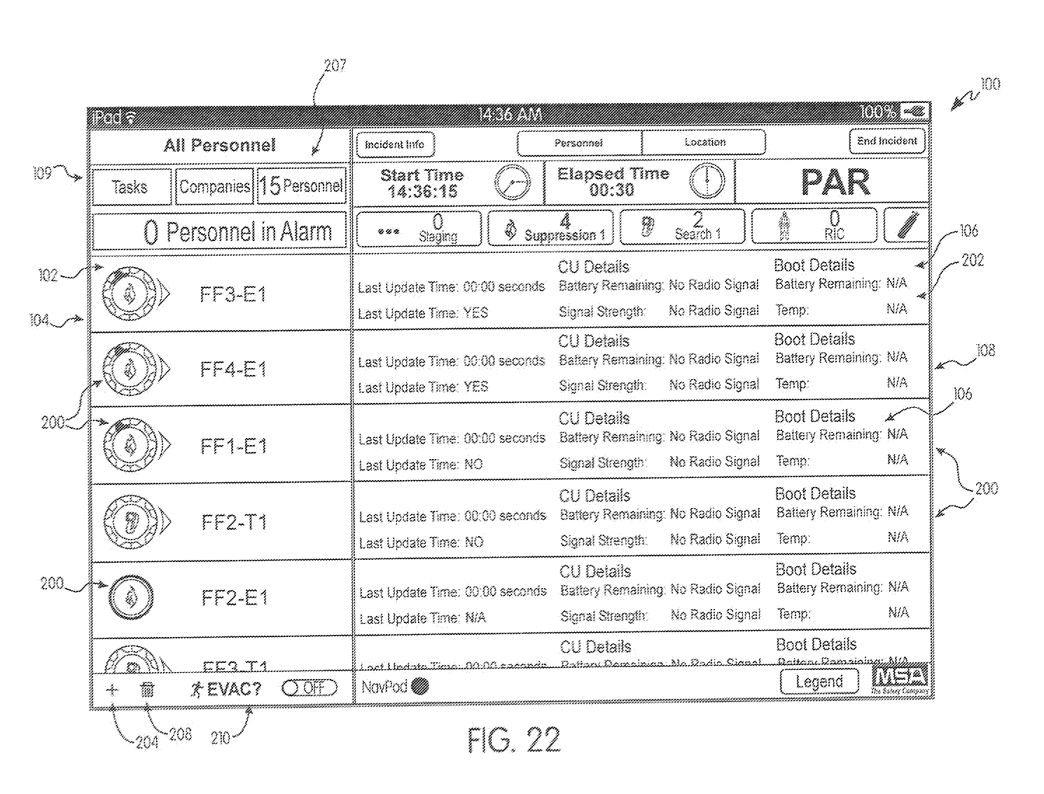

FIG. 22 illustrates the user interface 100 at the detailed personnel level (as indicated by data area 207, entitled “All Personnel”), which would be reached through the selection of a specific person in a company, such as data area 176 in FIG. 15. In this section, personnel (users U) are the primary data areas 102 in primary data section 104, and detailed user data 16 is displayed in the secondary data section 108. In the primary data section 104 of the embodiment of FIG. 21, each user U is represented in data area 200 in graphical form with certain user data 16, including the data and information provided for each user U in data areas 176 (i.e., the secondary data areas 106 in the secondary data section 108) of FIG. 15. However, in this embodiment, the user data 16 provided in textual form in data area 202 (in the secondary data section 108) includes last user update time, whether initialization is completed, the battery life of the user's radio 66, the signal strength of the user's radio 66, the battery life of the user's personal inertial navigation unit 72, and the sensed temperature at the user's personal inertial navigation unit 72. This information may be displayed in a variety of units and in a configurable manner. Again, each data area 202 in the secondary data section 108 is aligned and corresponds with a data area 200 in the primary data section 104, further illustrating the context-based navigation and interaction between the primary data section 104 and the secondary data section 108, whether data display or data functional interaction.

In the preferred and non-limiting embodiment of FIG. 22, by selecting the “+” button (data area 204) in the primary data section 104, the interface user U is led to the “Add Resource” menu (data area 191), as shown in FIG. 20. Also, as discussed above, the “trash” button (data area 208) is a context-based functional element that permits the deletion of data from whatever data area or portion the interface user U is presently navigating. Therefore, in this case, data area 208 allows for the deletion of a user U (personnel) from the company.

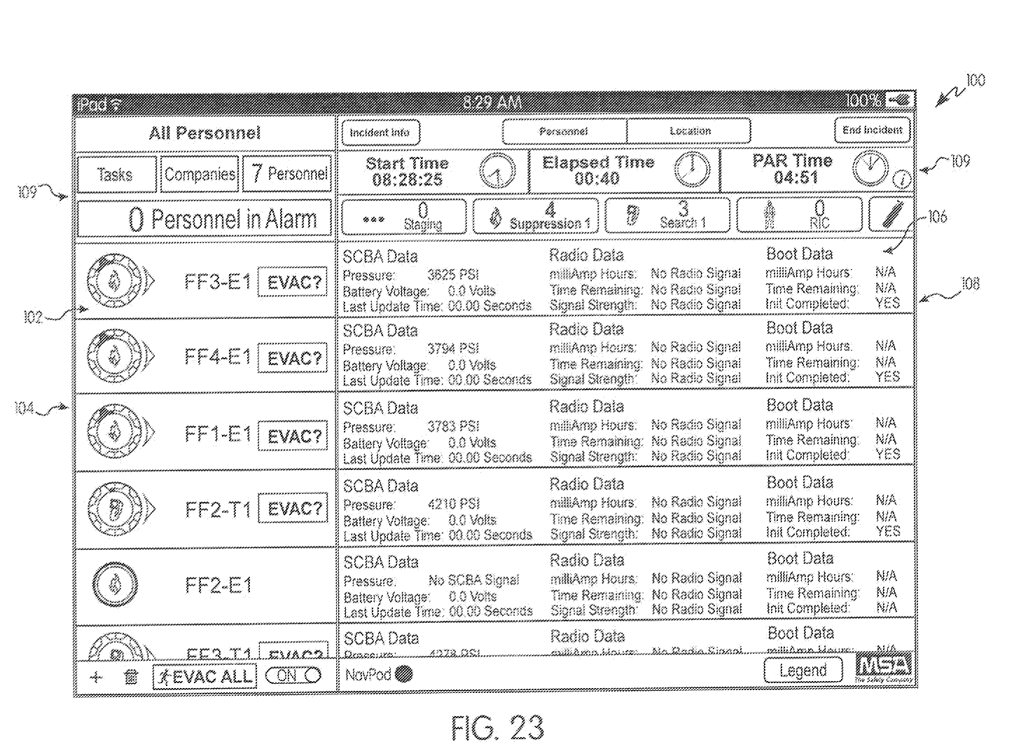

Additionally, and as discussed above, when initiating an evacuation via data area 210 (see FIG. 22), the interface user U can select which users U to evacuate, as illustrated in FIG. 23. In operation, the interface user U selects the “EVAC?” data area 212 to confirm that the user U should be evacuated. Once the evacuation command (whether with respect to a specific user U or a group of users U) is received, the status of the evacuation is displayed graphically in data area 214 (such as in connection with data area 176 (see FIG. 15)), which is now displayed in the primary data section 104 of FIGS. 22-24). In particular, and in this preferred and non-limiting embodiment, the data area 214 is dynamically modified to graphically represent the evacuation status, such as “evacuation command transmitted”, “evacuation command received by the radio of the user”, “evacuation command acknowledged by the user”, “evacuation complete”, and the like. This data area 214 may provide a graphical indication in the form of an icon, a color, text, and the like. In addition, data area 215 may be provided as a primary data area 102 and dynamically updated to provide a graphical indication of the status of the user U, again in the form of an icon, a color, text, and the like. This data area 215 ensures that the interface user U has a quick and accurate understanding of the exact status of each user U.

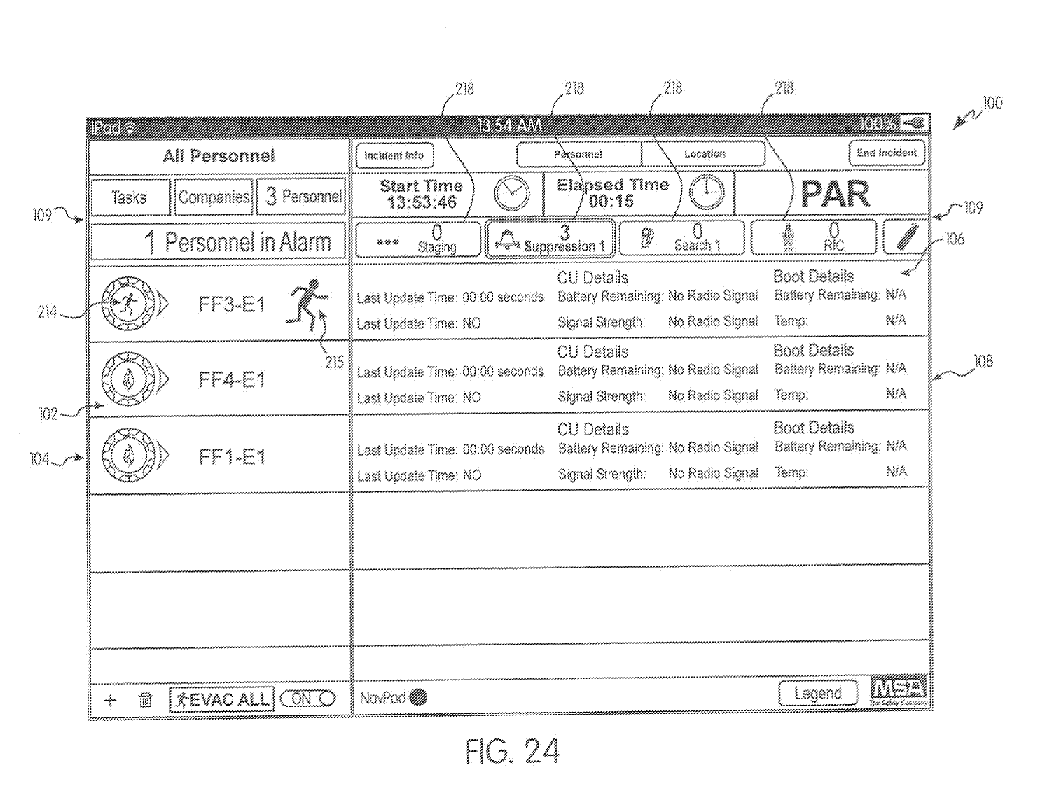

With continued reference to FIG. 24, the summary/control data section 109 in the primary data section 104 includes data area 216, which leads the interface user U to another level of the interface 100, typically the next level “up” from the current level. For example, if data area 216 was utilized at the level of FIG. 24 (user-specific level), the interface user U would be returned or led to the group-level of the interface (i.e., the level of FIG. 15). This same functionality can be used to move between any level of the organization of the user interface 100.

As further illustrated in FIG. 24 and as discussed above, the summary/control data section 109 in the secondary data section 108 includes data areas 218, which provides group-level information (e.g., the information of data areas 118, 120, and 122 of FIG. 9) to the interface user U. By selecting any one of the data areas 218 in FIG. 24, the interface user U is led to the selected group screen, e.g., FIG. 15. This facilitates quick movement between levels for use in permitting the interface user U to make expedited command decisions. In addition, the active, i.e., displayed, group (data area 218) is highlighted or otherwise set apart from the other groups (data areas 218). In this example, the interface user U is viewing global resource data 14, user data 16, and/or organizational data 82 relating to the “Suppression 1” group.

In another preferred and non-limiting embodiment, and as illustrated in FIG. 25, the interface 100 is configured to present or display a visual representation 220 of the scene or environment. In particular, this visual representation 220 can be referred to as a three-dimensional tactical map that allows the interface user U to view and understand the environment and incident. Further, it is envisioned that this visual representation 220 can be provided to the interface user U either dynamically, i.e., as it is happening, or afterward using a “playback” feature. As shown in FIG. 25, the visual representation 220 is displayed in full-screen mode, where it replaces or overlays both the primary data section 104 and the secondary data section 108.

With continued reference to FIG. 25, the visual representation 220 includes data area 222, which is a visual representation of the base station or other similar unit, such as the central controller 12, optionally in a portable form. Accordingly, data area 222 provides the location of the base station (or central controller 12) in relation to the incident and environment. Data area 224 is a graphical representation of each user U that is navigating in the environment. It is envisioned that each user's avatar (data area 224) may be displayed in a different color depending upon the state of the user U, such as “in alarm”, “in warning”, “good”, “loss of radio”, “selected”, “with SCBA”, “without SCBA”, and the like. In addition, when the interface user U selects a particular user's avatar 224, the selected user U can be enlarged (data area 226) or otherwise highlighted or set apart from the other users U. This allows the interface user U to quickly identify the specified or selected user U for making further command decisions.

With continued reference to FIG. 25, data area 227 is provided to indicate the number of personnel on any given floor of the structure, and this data area 227 may include a division number, a subdivision number, a floor number, the number of personnel located in that area or floor, and the like. Further, data area 227 is color coded to correspond with the floor map being presently displayed on the visual representation. Therefore, the interface user U can quickly identify which area is being viewed and other information about the area or floor. Further, the interface user U can quickly navigate between areas or floors (e.g., divisions) by selecting the desired division in data area 227. It is further envisioned that the visual representation can be in the form of a wire frame that represents the structure in three dimensions.

Still further, data area 229 (which, in this embodiment, takes the form of a dynamically-modified helmet on user's avatar (data area 224)) represents the area or floor where the user is located. This provides the interface user U with additional information about the exact location of each user U in the system 10. It is also envisioned that data area 224 or any other portion of the user's avatar (data area 224) is color coded or otherwise modified to indicate another condition of the user U or the company (or task) to which the user U is assigned.

Data areas 228 provide a graphical representation of the path of each user U (or user's avatar 224) including the previous locations that each specific user U has been. As with each user's avatar 224, the user's path 228 can be colored or otherwise modified to indicate the above-discussed state of the user U or any other desired information, e.g., division level, task assignment, company assignment, and the like. For example, the path 228 may turn red automatically when the user U is “in alarm,” and the path 228 may turn green when the user's avatar 224 is selected by the interface user U. Further,

As discussed, the visual representation 220 also includes a graphical representation of the building or structure (data area 230), whether in color-coded or wire frame form. This further enhances the ability of the interface user U to understand where each user U is navigating in the environment or scene. If data area 230 is in a wire frame form, it may be configured to illustrate any of the structural features of the building, such as floors, stairs, doors, windows, and the like. In addition, certain portions of data area 230 may be enhanced or highlighted to provide further indications to the interface user U, such as the location of the base station or central controller 12 with respect to the structure. Data area 232 represents a compass for use by the interface user U to determine additional location information regarding the users U and/or the building or structure. As shown in FIG. 25, data area 232 includes sides N, S, W, and E (to represent the orientation of the visual representation 220 or any other orientation at the scene. Further, these directions may correspond to the letters A, B, C, and D, which are common compass designations in firefighting environments, and these letters may be placed directly in the visual representation 220. It is further envisioned that a geographical map may be included with or accessible through the visual representation 220. Also, the presence and/or size of the grid can be selected using data element 233.

It is envisioned that the interface user U can interact with the visual representation 220 of the environment through various techniques, whether mouse-based, stylus-based, voice-based, gesture-based, and the like. For example, in one preferred and non-limiting embodiment, the interface user U can rotate, expand, shrink, and otherwise manipulate the visual representation 220 of the scene using gesture-based interaction with the screen of an appropriately-enabled user computer 62. As is known, this requires the user computer 62 to include the appropriate computer and display mechanism for implementation. Accordingly, the implementation of interaction between the interface user U and the interface 100 can be achieved by various devices and interface user U interactions depending upon the situation and computer hardware.

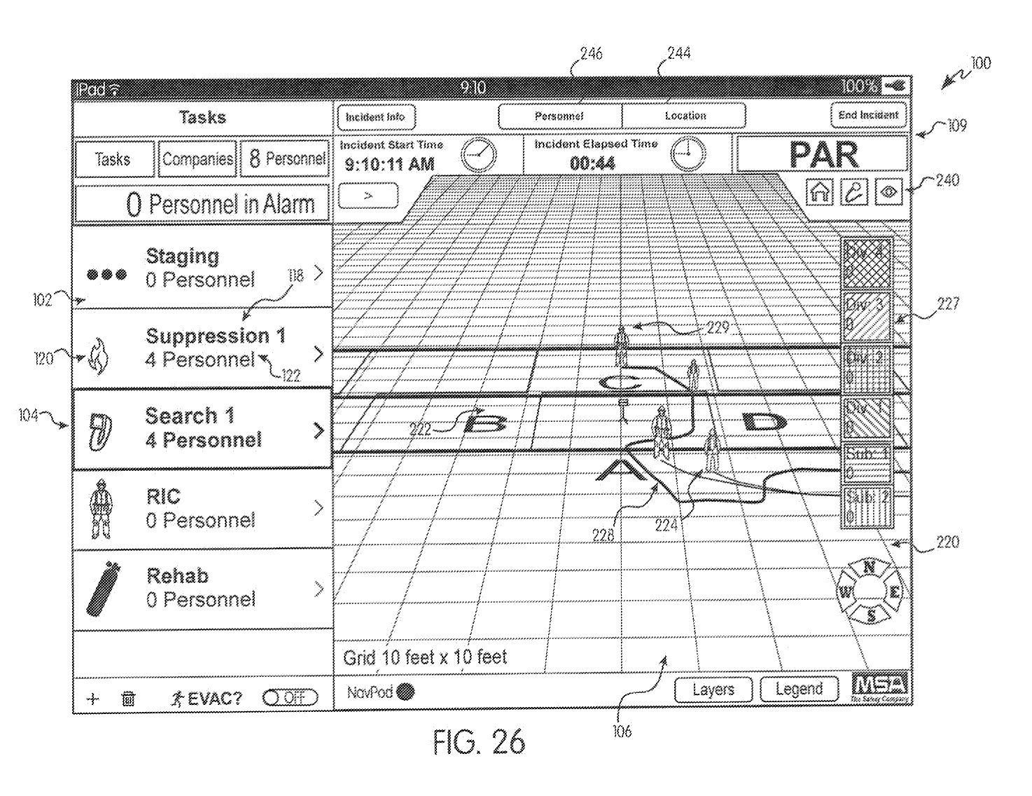

With continued reference to FIG. 25, the summary/control data section 109 provides additional tools for facilitating interaction between the interface user U and the visual representation 220. In particular, data area 234 leads to a building tool, as discussed hereinafter. Data area 236 provides options to the interface user U for drawing or otherwise placing indications directly on the visual representation 220. Data area 238 provides the interface user U with the ability to control the length of the visible path 228 lines. Further, data area 240 allows the interface user U to reset the viewpoint of the visual representation 220 to various locations, such as certain pre-configured locations or viewpoints. Data area 242 permits the interface user U to toggle between the full-screen visual representation (FIG. 25) and split-screen presentation, where the primary data section 104 includes certain of the previously-discussed data areas and the secondary data section 108 includes the visual representation 220 discussed above (e.g., FIGS. 26-28). The summary/control data section 109 may also include information regarding the incident start time, the incident elapsed time, the PAR timer, and the like (as discussed above).

As illustrated in the preferred and non-limiting embodiment of FIG. 26, which is directed to the split-screen view, the interface user U can select a particular group through interaction with at least one of data area 118, data area 120, or data area 122 of any specific group. This split-screen arrangement, i.e., the primary data section 104 including one or more of the above-discussed data areas and levels and the secondary data section 108 including the visual representation 220, can be quickly reached through interaction with data area 244 (“Location” button) in the summary/control data section 109. Similarly, if the interface user U would like to return to one or more of the above-discussed secondary data sections 108 with detailed hierarchical data, the interface user U can select data area 246 (“Personnel” button). In this manner, the interface user U can quickly move back and forth between various types of information and data, preferably in the secondary data section 108. In addition, when the interface user U selects a group in the primary data section 104, one or more of data areas 118, 120, and 122 are modified or highlighted so that the interface user U understands which group he or she is looking at in the secondary data section 108, i.e., the visual representation 220. Similarly, in the visual representation 220, the selected group will be highlighted or otherwise set apart from the remaining avatars 224 and paths 228.

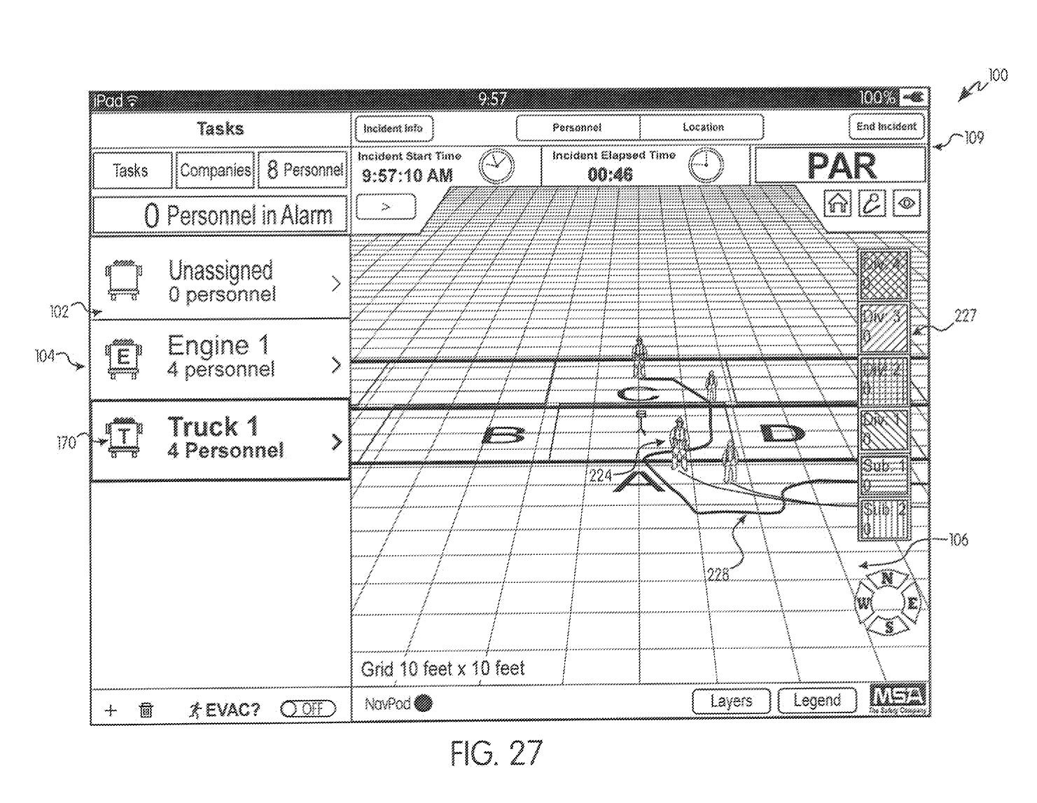

A further preferred and non-limiting embodiment of the interface 100 is illustrated in FIG. 27, which provides a company-level visual presentation 220 in the secondary data section 108. In particular, the companies that are in the selected group (FIG. 26) are exclusively shown in the visual presentation 220, or otherwise highlighted amongst the other users U and companies. For example, the paths 228 of the users U belonging to this company and/or group are fully visible, while other paths 228 may be made virtually transparent or otherwise diminished in detail. In the primary data section 104 of this embodiment, the primary data area 102 is in the form of data area 170 (in FIG. 15), which represents information and data at the company level. Of course, if multiple companies are part of the selected group, the interface user U could select between the various companies, and the visual representation 220 would be dynamically modified.

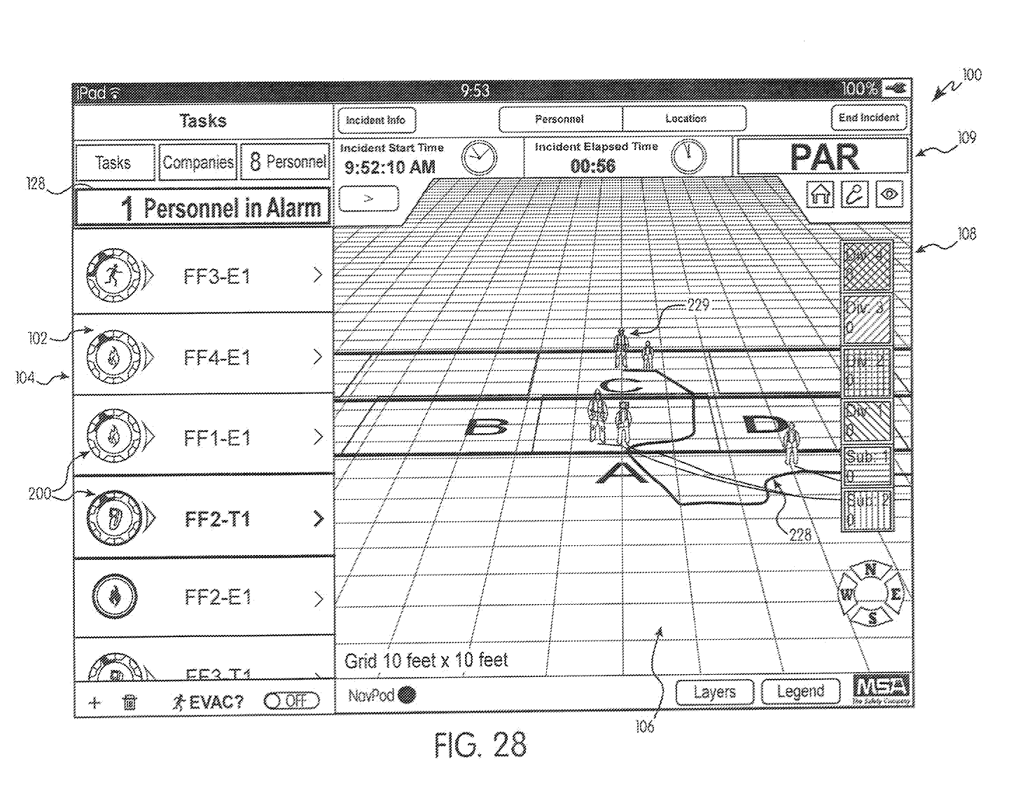

At the next level of detail, and as illustrated in FIG. 28, and in a further preferred and non-limiting embodiment, the users U of the selected company (FIG. 27) are listed. In particular, and in the primary data section 104, the primary data areas 102 include data areas 200 as shown, for example, in FIG. 22. Accordingly, and similarly, the visual representation 220 may include only visual information corresponding to the selected user U or preferably, ensure that the path line 228 and avatar 224 of the selected user U be highlighted or set apart from the other users U, which may have their paths 228 and avatars 224 partially transparent or otherwise diminished. Similarly, the avatar 224 of the selected user U may be enlarged or highlighted, such as using data area 226 discussed above. In addition, and as shown in the exemplary embodiment of FIG. 28, users U that are “in alarm” may also be set apart from the other users U, such by color coding or the like. Further, this alarm data 56 can be visually displayed in data area 200 in the primary data section 104, in data area 224 in the secondary data section 108, or in data area 128 in the summary/control data section 109.

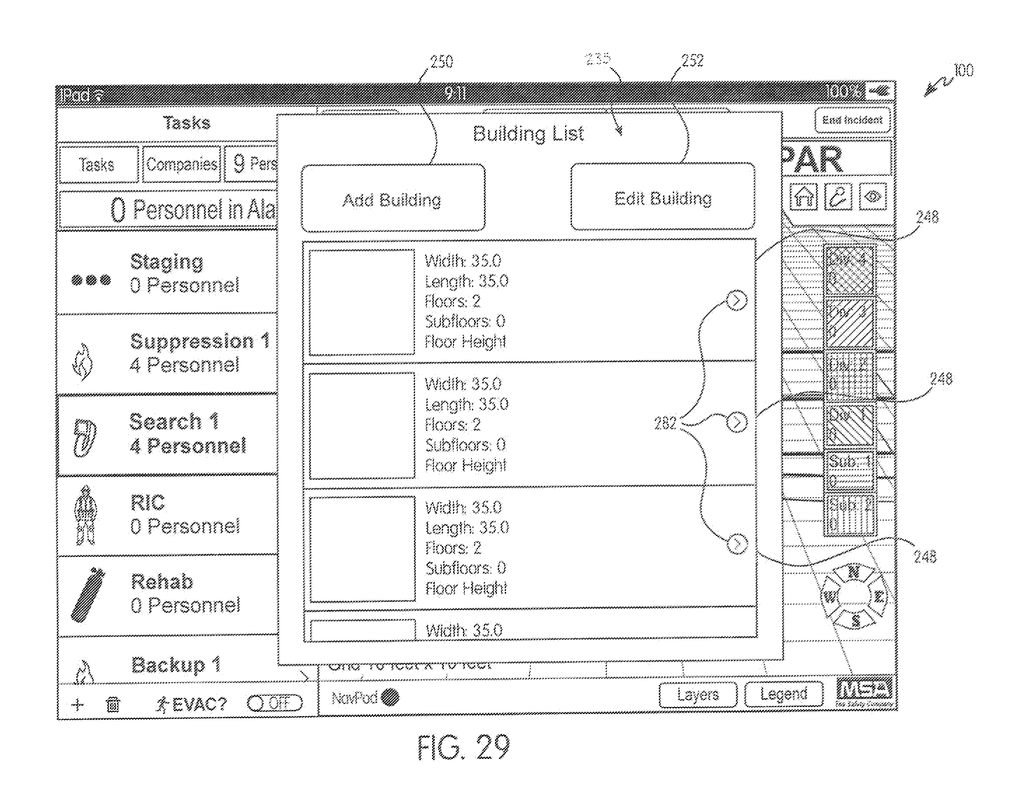

As discussed above in connection with the embodiment of FIG. 25, the interface user U is provided with certain tools in the summary/control data section 109 that allow for greater configuration of and interaction with the visual representation 220 of the scene or environment. In particular, data area 234 allows the interface user to work with and configure building information and data (data area 235 of FIG. 29). In particular, the information and data in data area 235 includes data areas 248 relating to the specific features of specified buildings, e.g., width, length, floors, subfloors, floor height, and the like. By using data area 250, the interface user U can add a new building or structure, and by using data area 252, the interface user U can edit existing information and data in data area 235. It is further envisioned that data area 248 can include any additional information regarding a particular structure or building, including, but not limited to, a picture of at least a portion of the building or structure, third-party information about the building or structure, attached documents or links to additional information about the building or structure, structure data 18, or any of the global resource data 14 captured before, during, or after the incident.

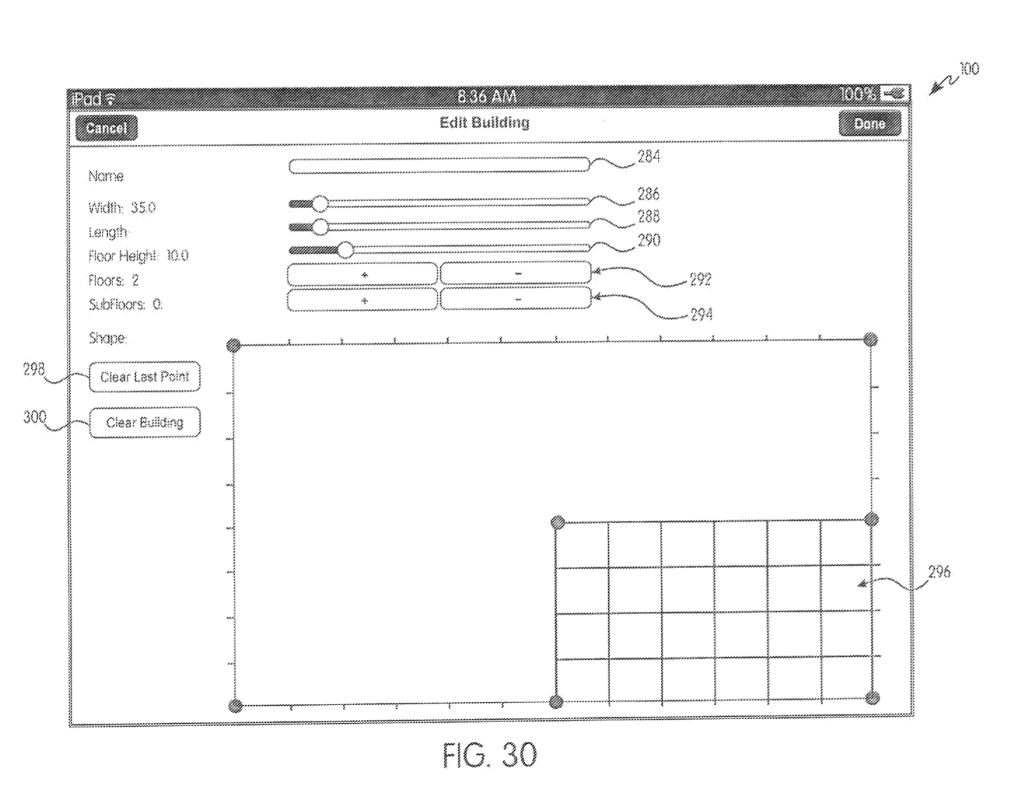

When selecting data area 282 of FIG. 29, the interface user U is moved to a screen where the building or structure information can be modified. In particular, and as illustrated in FIG. 30, the interface user U can enter the name of the building or structure in data area 284, adjust the width using a slide bar (data area 286), adjust the building or structure length using a slide bar (data area 288), and adjust the floor height using a slide bar (data area 290). Similarly, the number of floors can be adjusted using data area 292, and the number of subfloors can be adjusted using data area 294. Data areas 292 and 294 can be in the form of “plus” and “minus” buttons for adjusting up and down the number of floors and subfloors. The exact amounts, i.e., width, length, floor height, floors, and subfloors will be shown or displayed next to the corresponding data area.

In addition, using data area 296, the interface user U can drag and otherwise move various points along the corners of the building to provide a grid-based estimated shape for use in the visual representation 220. While data area 296 is shown in grid form, any level of detail and configuration could be provided for use by the interface user U. For example, it is envisioned that the interface user U could directly input the data and a model would be automatically produced, and/or the information could be imported from a link, another file, or some other third-party source. In addition, the interface user U could use drawing tools to provide a rough sketch of the floor plan or other aspects of the building or structure, and the interface 100 would adjust, modify, refine, resolve, or otherwise finalize these sketches. Using data area 298, the interface user, U can clear the last modified point to reset the previous building or structure shape, and the interface user U can use data area 300 to clear or remove the building or structure floor plan.

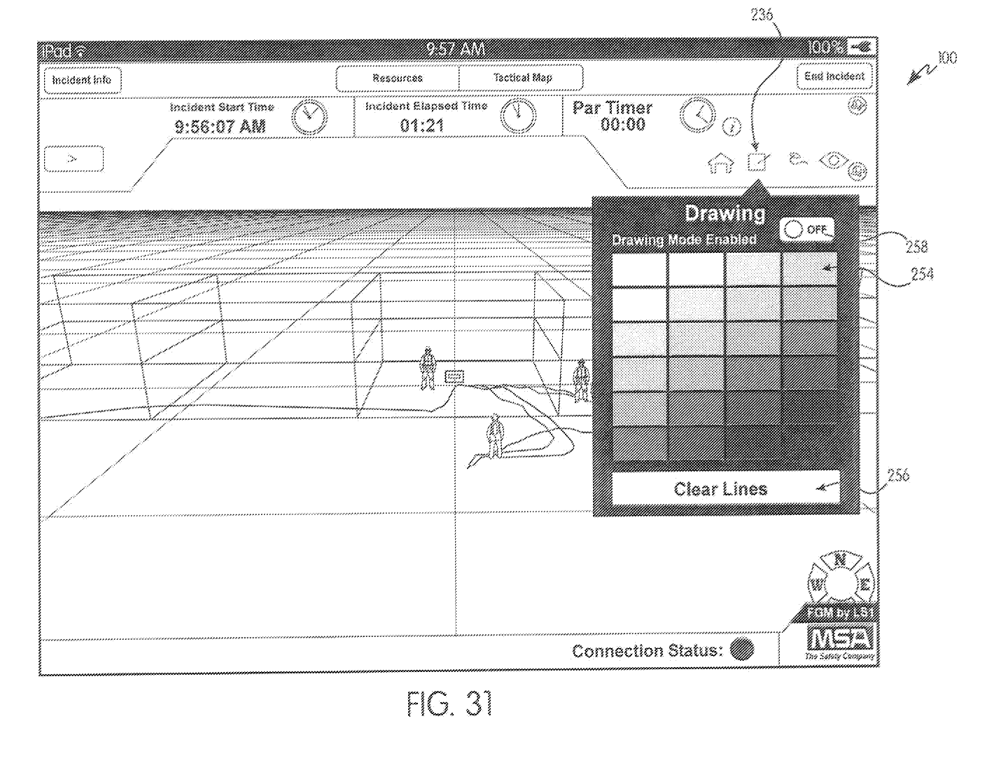

In another preferred and non-limiting embodiment, the interface user U is able to edit the graphical representation 220 (through interaction with data area 236), such as by drawing on or otherwise manipulating aspects of the building, structure, or other portions of the scene. Various colors or shades are able to be selected by using any of data areas 254, as illustrated in FIG. 31. In addition, data area 256 is used to clear or remove any of the lines or additions that the interface user U has included. In addition, data area 258 allows the interface user to disable drawing mode and return to the visual representation 220.

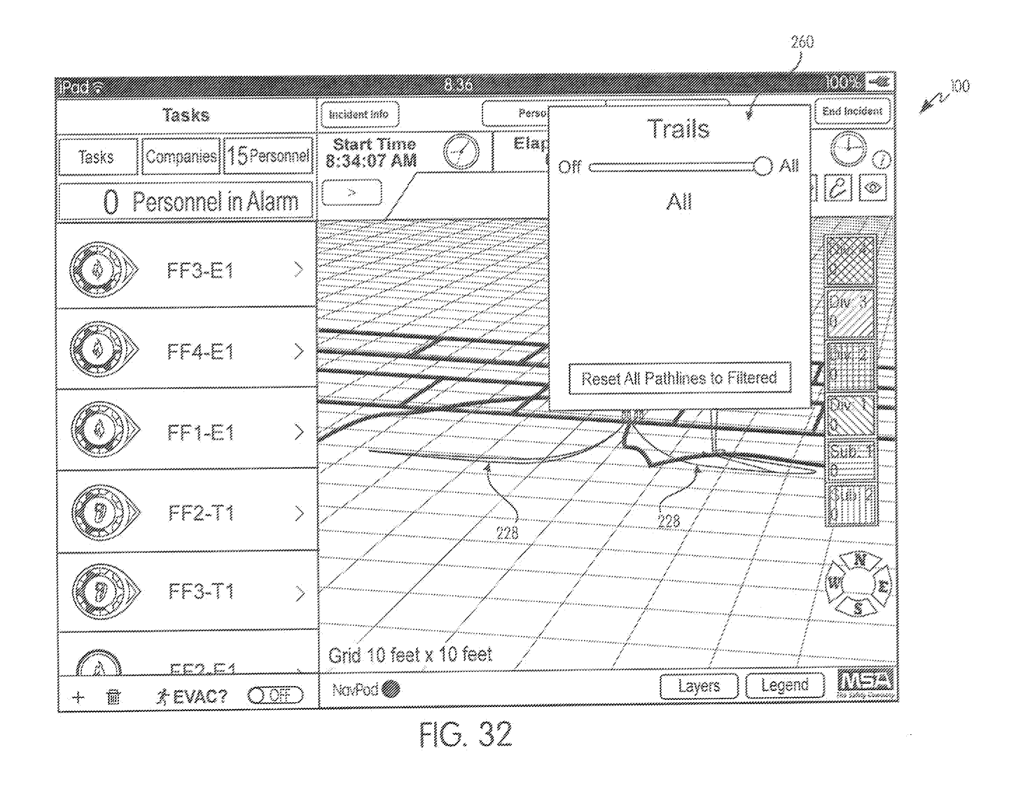

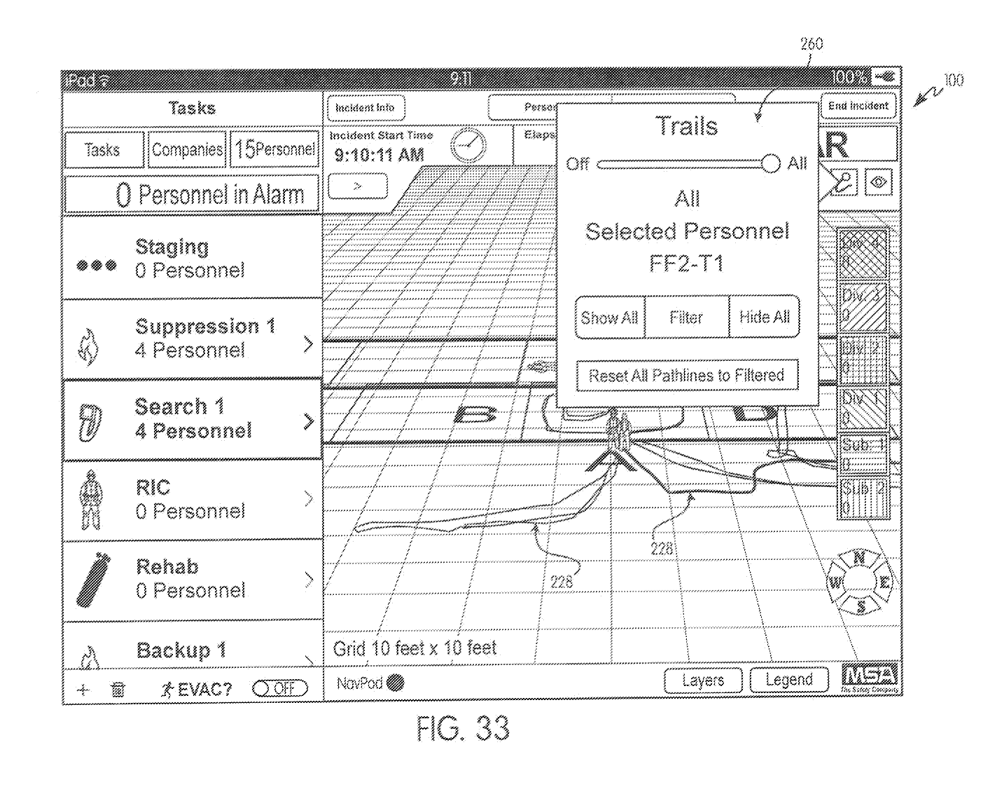

By selecting data area 238 (of FIG. 25), the interface user U is presented with data area 260, which represents another contextual interface or data area. In particular, data area 260 is based upon whether one or more users U are selected (FIG. 33) or not selected (FIG. 32). When no specific personnel are selected, and as shown in FIG. 32, the interface user U can turn the paths (data area 228) on or off, as well as reset the paths to some initial or intermediate point. It is also envisioned that the interface user U can control or select the length of the paths 228 visible in the visual representation 220. If the interface user U has selected a specific user U (as shown in FIG. 33, where the personnel selected includes “FF2-T1”), that users U path (data area 228 is exclusively shown, highlighted, or otherwise set apart from the other paths. In addition, and as seen in FIG. 33, the interface user U can select whether to show all paths, hide all paths, or shown only the selected paths (e.g., the path of the selected user U). It is further envisioned that the interface user U can be provided with additional controls for manipulating the view or viewpoint of the visual representation, such as through a selectable menu (e.g., data area 227), a drop-down box, a selectable viewpoint menu (e.g., north side, south side, west side, east side, and plan), and the like. As discussed, the interface user U can reset to the default or initial view.

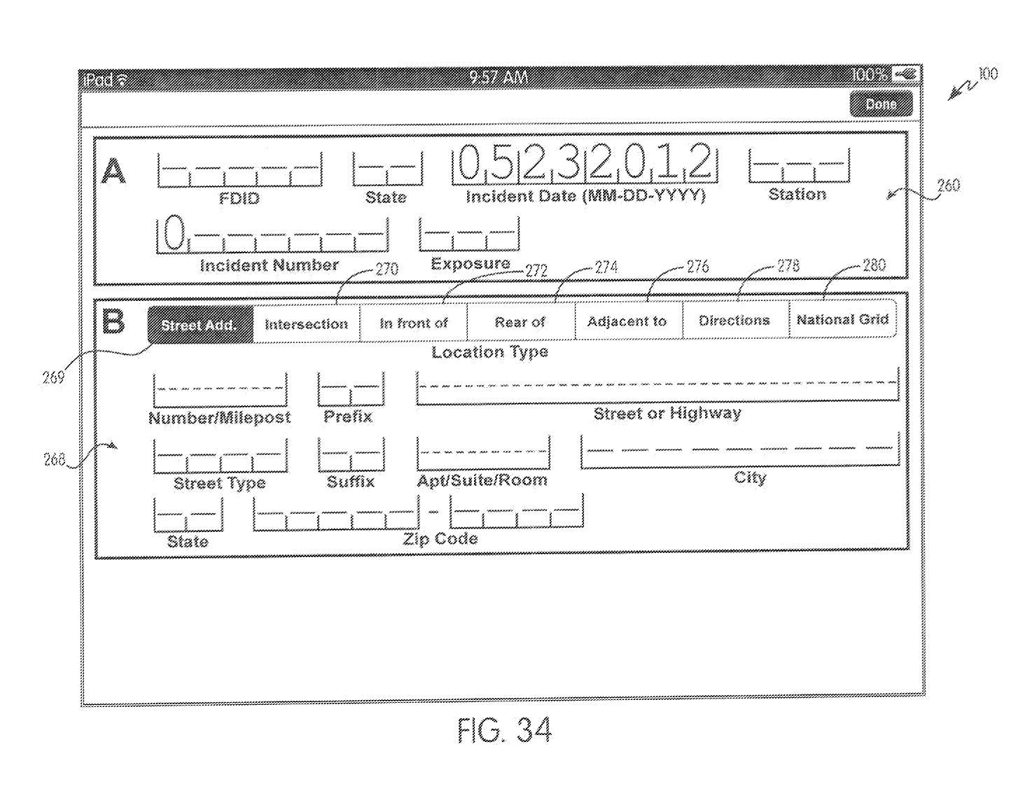

By selecting the “Incident Info” button (data area 266) in, e.g., FIG. 25, the interface user U is provided with certain information and data regarding the incident. For example, as illustrated in the preferred and non-limiting embodiment of FIG. 34, the interface user U can provide certain information in data area 266 including, but not limited to, FDID, State, Incident, Date, Station, Incident Number, and/or Exposure. In data area 268, the interface user U is able to input or edit information regarding the incident at a greater level of detail. In particular, a number of tabs (data areas 269, 270, 272, 274, 276, 278, and 280) are presented to the interface user U for data input. In the example of FIG. 34, data area 269 (street address) has been selected, such that the interface user U can input the street address of the incident. By selecting data area 270, the interface user U can enter information about the intersection nearest the incident, and by using data area 272, the interface user U can enter information about the placement or relative positioning (i.e., “in front of”) of the incident or scene. Similarly, the data area 274 is used to provide relational location information (i.e., “rear of”) relating to the incident, as is also the case with data area 276 (i.e., “adjacent to”). Using data area 278, the interface user U can enter directions to the incident; and finally, by using data area 280, the interface user U can enter information with relation to the national grid.

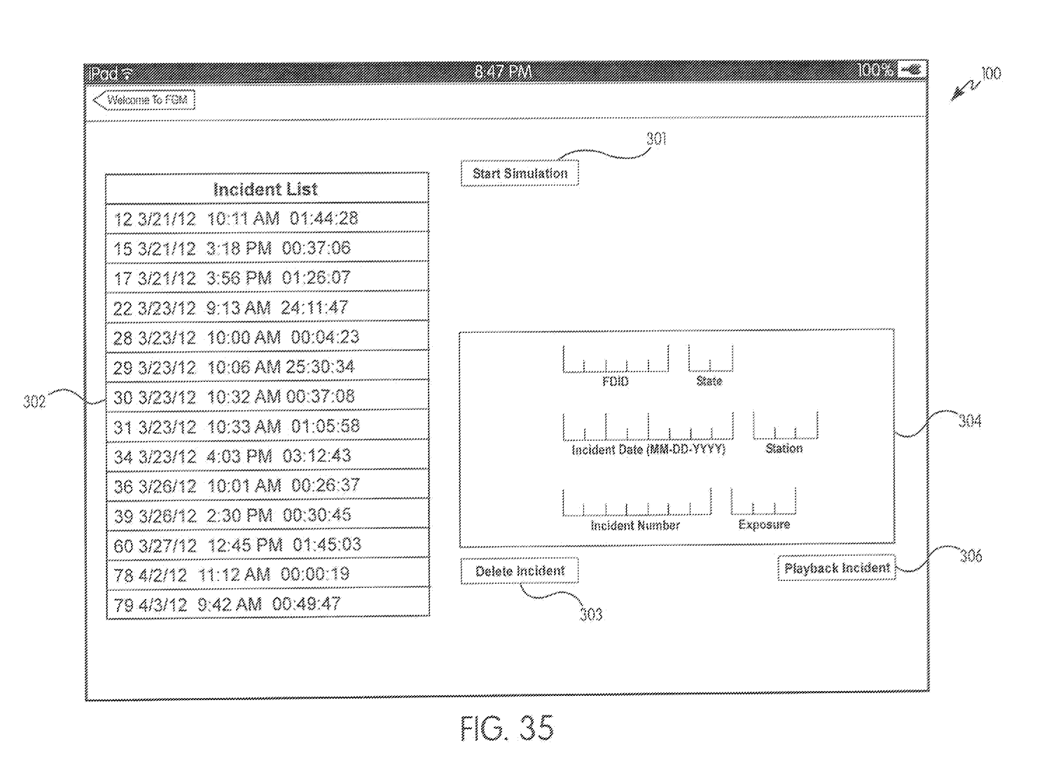

By selecting the “Playback Incident” button (data area 112) of FIG. 8, the interface user U is presented with a selection screen for configuring this playback, which is illustrated in one preferred and non-limiting embodiment in FIG. 35. This selection screen includes data area 302, which represents a list of stored incidents that can be selected by name. Data area 304 provides certain incident information, such as all or a portion of the information input in data areas 266 or 268. In one embodiment, the incident information provided in data area 304 corresponds to the incident selected by the interface user U in data area 302. Once the selection has been made, the interface user U uses the “Playback Incident” button (data area 306) to start the playback. The interface 100 will then play back the incident, including some or all of the above-discussed information that was being captured, processed, and output by, from, or within the system 10 during the incident. Further, the interface user U can start a simulation using the “Start Simulation” button (data area 301) or delete and incident using the “Delete Incident” button (data area 303).

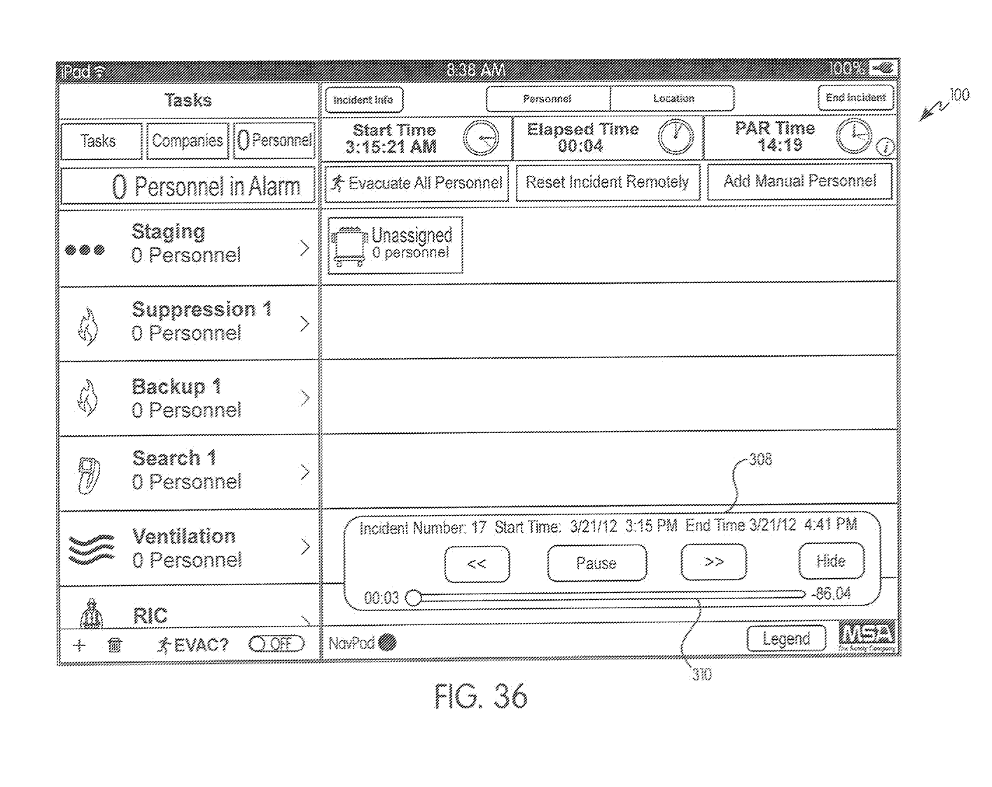

It is envisioned that the interface user U can use this playback function to track exactly the decision-making process and information as it was flowing through this incident at the time. In addition, any amount of detail or interaction can be provided to the interface user U, such as down to the level of watching the previous interface user's interaction with the interface 100 at a click-by-click level. The interface user U viewing the playback may be able to control the level of detail that is being viewed, as well as the timeline of the incident, which is illustrated in FIG. 36. In particular, and by using data area 308, the interface user U can initiate the playback sequence, rewind the playback, pause the playback, fast forward the playback, and/or hide the playback sequence. Further, by using data area 310, the interface user U can use a slide bar to pick a specific time point during the incident. In this manner, the interface unit U can “jump” around the incident as it is being played back in order to review the decisions that were made. This, in turn, allows for a full review process of the incident command structure and operation for strategic purposes and improvement of the processes.

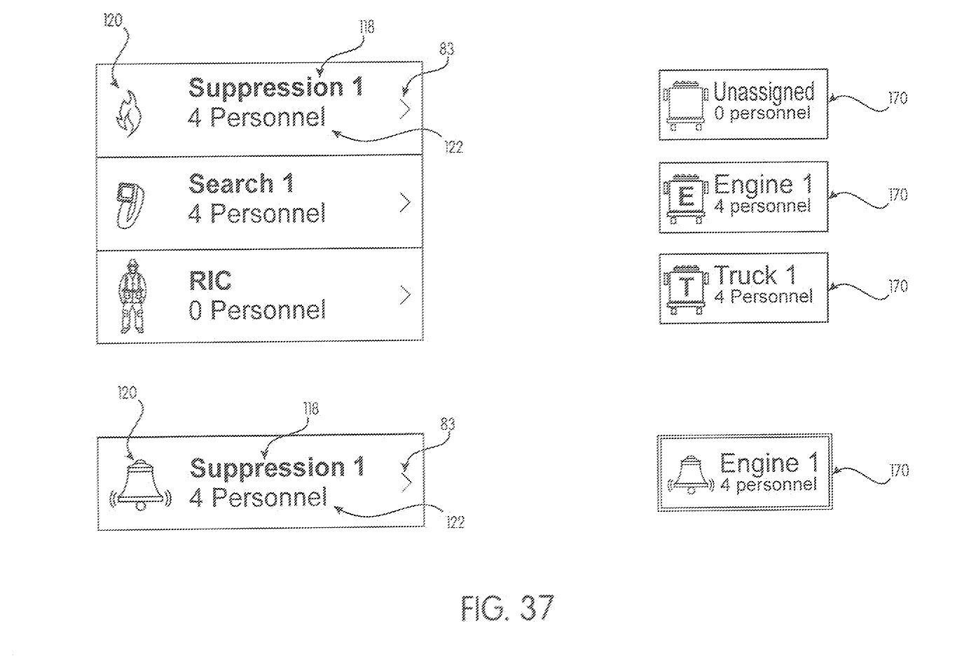

FIG. 37 illustrates additional embodiments for the group-level data area (data areas 118, 120, 122) and the company-level data area (data area 170). In particular, and in this embodiment, the data area 120 of the group-level data area is at least partially colored or shaded, such that it indicates additional information, such as an alarm state. Similarly, colors or shading could be used in connection with company-level data areas 170, such as in the form of an outline or other highlight.

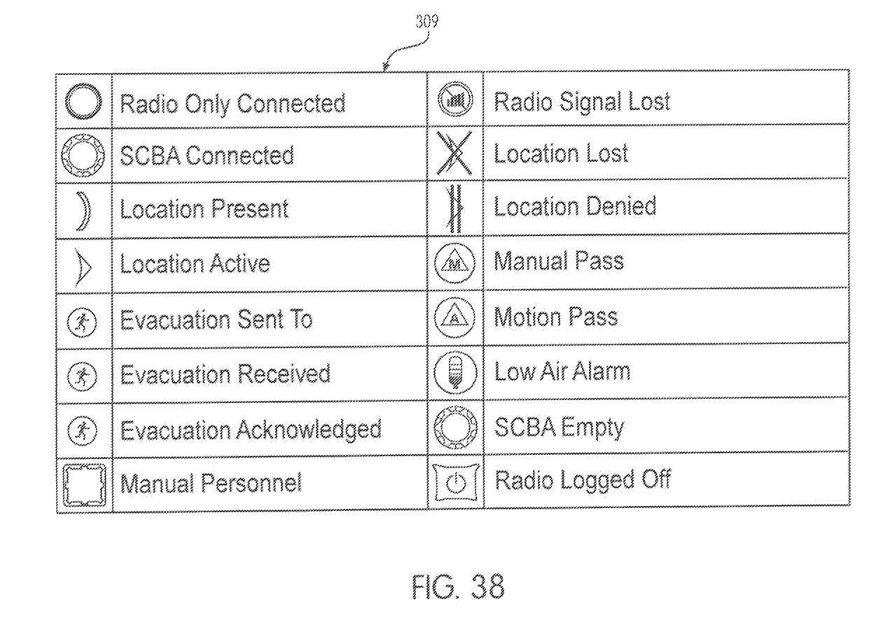

When the “Legend” button (data area 307 displayed in, e.g., FIG. 9) is selected, the interface user is presented with data area 309. Data area 309 provides a partial or complete listing of the graphical representations and/or icons that are used in connection with some or all of the data areas in the primary data section 104 and/or the secondary data section 108. As shown in FIG. 38, the icons presented may represent radio only connected, SCBA connected, location present, location active, evacuation sent to, evacuation received, evacuation acknowledged, manual personnel, radio signal lost, location lost, location denied, manual PASS, motion PASS, low air alarm, SCBA empty, radio logged off, and the like. Of course, data area 307 may include a legend of any of the icons, visual representations, graphics, terms, phrases, and structures used throughout the interface 100. Further, data area 307 may be in the form of a pop-up box, a drop-down menu, a separate screen, and the like.

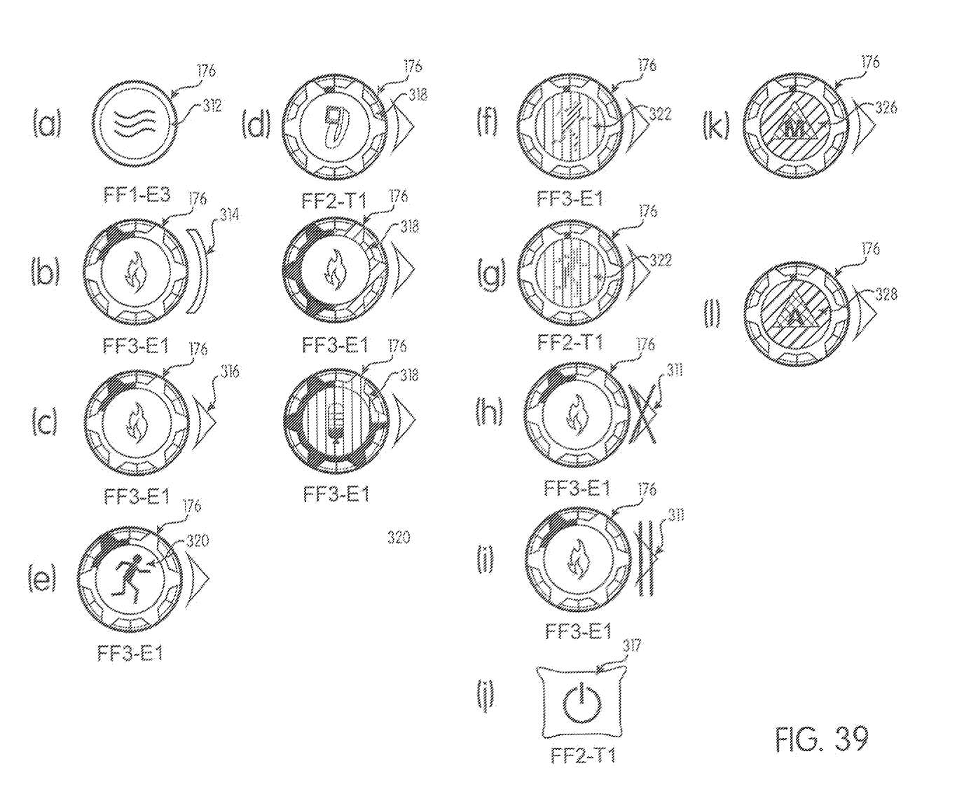

As discussed, and at the personnel-level (i.e., user U level), certain information and data can be graphically provided in data area 176, as illustrated in one preferred and non-limiting embodiment in FIGS. 39(a)-(j). Data area 312 of FIG. 39(a) indicates that the user U is only radio 66 connected, and data area 314 of FIG. 39(b) indicates that the personal inertial navigation unit 72 of the user U is connected but has not yet been initialized. Data area 316 of FIG. 39(c) indicates that the personnel inertial navigation unit 72 is connected and has been initialized. Data area 318 in FIG. 39(d) indicates that the SCBA 70 is connected, and the ring indicates how much air is left in the SCBA 70. Further, FIG. 39(d) shows three states of data area 318 with varying amounts of air left in the SCBA 70, as graphically denoted by the size or circumference of the ring. In addition, it is envisioned that the ring can take various colors based upon the amount of air left in the SCBA 70, e.g., green for half service or above, yellow/orange for quarter service to half service, and red for below quarter service. Further, and with continued reference to FIG. 39(d), data area 315 indicates or provides a low air alarm.

As discussed above, when an evacuation command has been issued by the interface user U, data area 176 can indicate that the evacuation command has been sent (data area 320 in FIG. 39(e)), that the evacuation command has been received by the SCBA 70 (data area 322 in FIG. 39(f)), and that the evacuation command has been acknowledged by the user U (data area 324 in FIG. 39(g)). In FIG. 39(h), data area 311 indicates that system 10 has lost the location of the user U, and in FIG. 39(i), data area 313 indicates that the user U is “location denied”,” e.g., a mismatch has occurred between users or associated equipment, “ownership” or assignment issues have occurred, and the like. In general, the “location denied” data area 313 indicates that the user-associated data is not available or not reliable. In FIG. 39(j), data area 317 indicates that the user's radio 66 has been logged off of the system 10. As shown in FIGS. 39(k) and 39(1), data area 176 can be used to display alarm data 56 (or alarm state), such as that the user U has manually activated an alarm (data area 326 in FIG. 39(k)) or that an alarm has been initiated based upon the motion of the user U (data area 328 in FIG. 39(l). Generally, it is envisioned that data area 176 (or any portion thereof) can be used to provide any information to the interface user U dynamically and in graphical format.

FIG. 39 represents additional detail that can be presented to the interface user U in connection with a specific user U navigating in the environment or at the incident. In particular, data area 330 can be used to provide user-specific information and allow for user-specific configuration using the tools provided in data area 332. Further, summary information, such as at the group- or company-level can be provided in data area 330. For example, this summary information may include the incident start time, the name of the user U, the group of the user U, and other visual or graphic information, such as the information provided in the various embodiments of FIGS. 38 and 39.

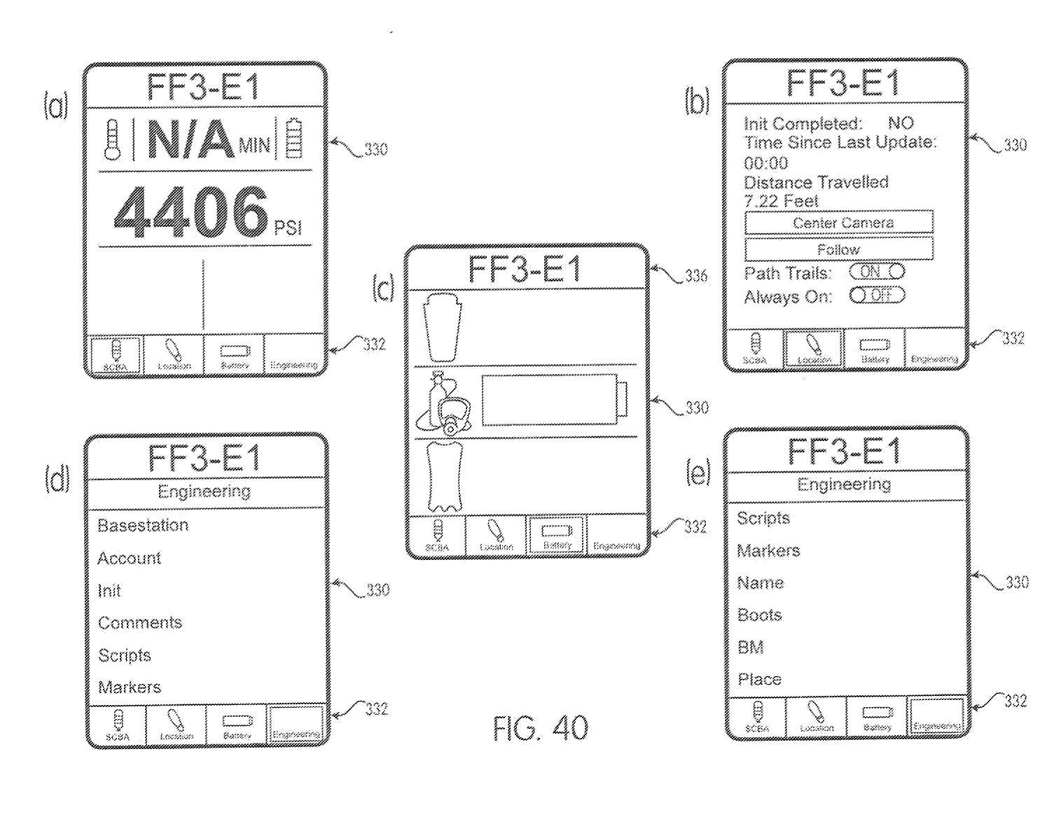

With specific reference to the preferred and non-limiting embodiment of FIGS. 40(a)-(e), data area 330 provides a tab-based menu (data area 332) including an “SCBA” button (data area 338), a “Location” button (data area 340), a “Battery” button (data area 341), and an “Engineering” button (data area 343). As seen in FIG. 40(a), selection of data area (or tab) 338 provides the interface user U with data and information relating to the SCBA 70 of the user U, such as the user's name, the amount of air remaining (e.g., graphically or in the number of minutes remaining) in the SCBA 70, the temperature at or near the SCBA, the pressure in the tank of the SCBA 70, and the like. As seen in FIG. 40(b), selection of data area (or tab) 340 provides the interface user U with data and information relating to the location system and/or the personal inertial navigation unit 72, such as the user's name, whether initialization has been completed, the time since the last update, the distance travelled, functionality to center the camera (or view) on the specified user U, functionality to permit the view to “follow” the specified user U, functionality to toggle the user's path on or off, functionality to ensure that the specified user's path is always on, and the like.

As seen in FIG. 40(c), selection of data area (or tab) 341 provides the interface user U with data and information relating to the batteries of the various components worn or used by the user U, such as the battery life for components of the SCBA 70, the alarm device 75, the radio 66, the personal inertial navigation unit 72, and the like. This data and information may be provided to the interface user U in textual, numerical, and/or graphical form. Finally, as seen in FIGS. 40(d) and (e), selection of data area (or tab) 343 provides the interface user (and/or system administrator) with optional development tools used for viewing, modifying, managing, and/or controlling various functional aspects of the system 10 and user interface 100. For example, these development tools may include options or interfaces to engage in further development and/or control of the system 10 and user interface 100.

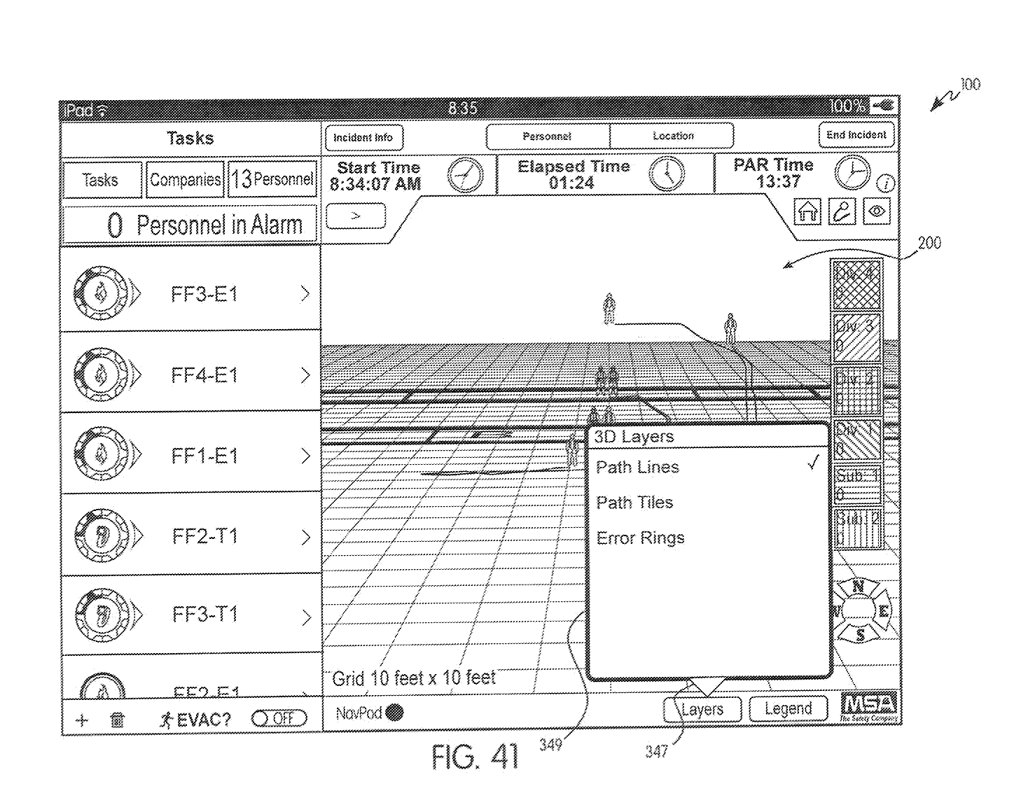

In a further preferred and non-limiting embodiment, and as seen in FIG. 41, a “Layers” button (data area 347) is provided to the interface user U to facilitate additional control of the three-dimensional visual representation 200. For example, and upon selection of data area 347, data area 349 is displayed to the interface user U. Data area 349 allows the interface user U to toggle the path lines (data area 228) “on” or “off”, toggle the paths from lines to tiles, display the accumulated error (as an “error ring”) reported by the user's personal inertial navigation unit 72, and toggle “night mode” “on” or “off”, which adjusts the display (e.g., colors, contrasts, backlighting, and the like) for the interface user U according to the time of day (or night).

In this manner, the presently-invented system 10 and interface 100 provides incident management and monitoring systems and methods that are useful in connection with navigation systems and other systems that are deployed during an incident and in an emergency situation. The present invention provides access to, processing of, and control over various data streams in order to assist interface users U and command personnel in making dynamic decisions in an emergency environment.

What is claimed is:

1. An incident management and monitoring system, comprising:
at least one central controller configured to receive global resource data, user data, and organizational data; wherein the global resource data comprises at least one of the following: structure data, environment data, scene data, geographic data, computer aided dispatch data, municipal data, government data, standards data, vehicle data, tag data, weather data, aid data, or any combination thereof; wherein the user data comprises at least one of the following: personnel data, equipment data, wireless-enabled device data, alarm device data, self contained breathing apparatus data, navigation data, status data, alarm data, or any combination thereof; and wherein the organizational data comprises at least one of the following: operations data, section data, branch data, division data, group data, resource data, or any combination thereof; and
at least one user interface in direct or indirect communication with the at least one central controller and configured to display content comprising at least one of the following: at least a portion of the global resource data; at least a portion of the user data, at least a portion of the organizational data, at least one selectable element, at least one configurable element, at least one control element, at least one user input area, visual data, processed data, or any combination thereof.

2. The system of claim 1, further comprising at least one user computer configured to receive, process, and/or utilize at least a portion of the global resource data, the user data, and/or the organizational data to generate the content for display at the at least one user interface.

3. The system of claim 1, further comprising a plurality of central controllers in wireless communication with each other and configured to receive and transmit data between and among the plurality of central controllers.

4. The system of claim 1, wherein at least a portion of the user data is received from at least one wireless-enabled device associated with a specified user.

5. The system of claim 4, wherein the at least one wireless-enabled device is in the form of and/or configured to receive data from at least one of the following: a radio, user equipment, a sensor, a self contained breathing apparatus, a personal navigation unit, a personal inertial navigation unit, a signal emitting device, a tag, a radio frequency identification tag, an alarm device, or any combination thereof.

6. The system of claim 1, wherein the content displayed to the at least one user at the at least one user interface is filtered based upon an authorization level of the at least one user.

7. The system of claim 1, wherein interaction with the content displayed to the at least one user at the at least one user interface is limited based upon an authorization level of the at least one user.

8. The system of claim 1, wherein the at least one central controller is further configured to receive interface data directly or indirectly from the at least one user interface.

9. The system of claim 8, wherein the at least one central controller is further configured to transmit data to at least one wireless-enabled device associated with a specified user based at least partially on the interface data.

10. The system of claim 1, wherein the at least one central controller is in the form of a transportable unit configured to be positioned at the scene of an incident.

11. The system of claim 1, wherein the at least one central controller is further configured to receive organizational data, and wherein the at least one user interface is further configured to display content comprising at least a portion of the organizational data.

12. The system of claim 11, wherein the organizational data comprises at least one of the following: operations data, section data, branch data, division data, group data, resource data, or any combination thereof.

13. The system of claim 1, wherein the at least one central controller and/or at least one computer associated with the at least one user interface is configure to store at least a portion of the global resource data, the user data, and/or the organizational data relating to a specified incident.

14. A user interface for incident management and monitoring, comprising:
on at least one computer having a computer readable medium with program instructions thereon, which, when executed by a processor of the computer, cause the processor to:
receive data from at least one central controller, the data comprising at least one of the following: global resource data, user data, organizational data, or any combination thereof;
transmit data based at least in part upon user interaction with the user interface;
generate content for display to the at least one user, the content comprising: (i) at least one primary data area displayed in at least one primary data section; and (ii) at least one secondary data area displayed in at least one secondary data section; wherein the at least one secondary data area is associated with at least one primary data area; and
based at least partially upon user input, at least partially modify the association between the at least one secondary data area and the at least one primary data area.

15. The user interface of claim 14, wherein at least one of the at least one primary data area and the at least one secondary data area comprises at least one of the following: global resource data, user data, resource data, organizational data, work zone data, work cycle data, work assignment data, work control data, accountability data, role data, self contained breathing apparatus data, air data, air status data, air alarm data, alarm data, navigation data, visual data, time data, incident data, or any combination thereof.

16. The user interface of claim 14, wherein at least one of the at least one primary data section and the at least one secondary data section include at least one interactive data area configured to control at least a portion of the content displayed on at least a portion of the user interface.

17. The user interface of claim 14, wherein the at least one primary data area is a grouping of associated resources, and the at least one secondary data area comprises further data related to at least one of the associated resources.

18. The user interface of claim 17, wherein the modification comprises moving at least one resource from at least one first primary data area to at least one other primary data area.

19. The user interface of claim 18, wherein at least one of the at least one primary data section and the at least one secondary data section at least partially comprise a visual representation of at least one environment in which at least one user is navigating.

20. The user interface of claim 19, wherein the visual representation of the at least one environment is user-configurable.
